(19) United States
(12) Patent Application Publication
(10) Pub. No.: US 2021/0387406 A1
(43) Pub. Date: Dec. 16, 2021

(54) Method for Heating Fiber-Reinforced Thermoplastic Feedstock

(71) Applicant: Arevo, Inc., Milpitas, CA (US)

(72) Inventors: Steven George Manuel, San Mateo, CA (US); Leonid Michael Treyger, Orlando, FL (US); Xuance Zhou, Milpitas, CA (US)

(73) Assignee: Arevo, Inc., Milpitas, CA (US)

(21) Appl. No.: 16/901,065

(22) Filed: Jun. 15, 2020

(51) Int. Cl. B29C 64/141; B23K 26/073; B23K 26/082; B23K 26/06; B23K 26/03; B33Y 10/00; B33Y 70/10; B33Y 50/00; B29C 64/386; B29C 64/268

(52) U.S. Cl. CPC B29C 64/141; B23K 26/0736; B23K 26/082; B23K 26/0648; B23K 26/034; B23K 2103/172; B33Y 70/10; B33Y 50/00; B29C 64/386; B29C 64/268; B33Y 10/00

(57) ABSTRACT

An additive manufacturing system is disclosed that heats a feedstock and a workpiece in preparation for depositing and tamping the feedstock onto the workpiece. The system comprises a first laser/optical instrument pair for precisely heating the feedstock and a second laser/optical instrument pair for precisely heating the workpiece. The laser beam from each laser is shaped into an ellipse and each beam is rotated around an angle of rotation to ensure that the feedstock and the workpiece are properly heated. The system employs feedforward, a variety of sensors, and feedback to adjust the angle of rotation of each laser beam.

### CROSS-REFERENCE TO RELATED APPLICATIONS

This application is related to Unites States patent application Ser. No. ______, entitled “Method for Heating Fiber-Reinforced Thermoplastic Workpiece,” filed on Jun. __, 2020 (Attorney Docket 3019-273us1), which application is incorporated by reference.

The following are hereby incorporated by reference:
(i) U.S. Pat. No. 10,076,870, entitled “Filament Guide,” issued on Sep. 18, 2018 (Attorney Docket 3019-142us1); and
(ii) U.S. patent application Ser. No. 15/959,213, entitled “Variable-Contour Compaction Press,” filed on Apr. 21, 2018 (Attorney Docket 3019-171us1); and
(iii) U.S. patent application Ser. No. 15/959,214, entitled “Variable-Contour Compaction Roller,” filed on Apr. 21, 2018 (Attorney Docket 3019-172us1); and
(iv) U.S. patent application Ser. No. 15/959,215, entitled “Self-Cleaning Variable-Contour Compaction Press,” filed on Apr. 21, 2018 (Attorney Docket 3019-173us1); and
(v) U.S. patent application Ser. No. 16/023,197, entitled “Filament Cutter,” filed on Jun. 29, 2018 (Attorney Docket 3019-161us1 ARVO 7926); and
(vi) U.S. patent application Ser. No. 16/023,210, entitled “Filament Accumulator or Tensioning Assembly,” filed Jun. 29, 2018 (Attorney Docket 3019-169us1 ARVO 7916); and
(vii) U.S. patent application Ser. No. 16/505,541, entitled “Adding a Segment of Fiber-Reinforced Thermoplastic Filament in a Curve,” filed Jul. 8, 2019 (Attorney Docket 3019-201us1); and
(viii) U.S. patent application Ser. No. 16/690,765, entitled “Heater for Thermoplastic Filament and Workpiece,” filed Nov. 21, 2019 (Attorney Docket 3019-204us1); and
(ix) U.S. patent application Ser. No. 16/792,150, entitled “Thermoplastic Mold with Tunable Adhesion,” filed on Feb. 14, 2020 (Attorney Docket 3019-243us1); and
(x) U.S. patent application Ser. No. 16/792,156, entitled “Thermoplastic Mold with Implicit Registration,” filed on Feb. 14, 2020 (Attorney Docket 3019-245us1); and
(xi) U.S. Patent Application Ser. No. 63/025,109, entitled “Heating System for Fiber-Reinforced Thermoplastic Feedstock and Workpiece,” filed May 14, 2020 (Attorney Docket 3019-205pr1); and
(xii) U.S. Patent Application Ser. No. 63/029,172, entitled “Heating System for Fiber-Reinforced Thermoplastic Feedstock and Workpiece,” filed May 22, 2020 (Attorney Docket 3019-205pr2); and
(xiii) U.S. patent application Ser. No. 16/889,830, entitled “Heating System for Fiber-Reinforced Thermoplastic Feedstock and Workpiece,” filed Jun. 2, 2020 (Attorney Docket 3019-205us1).

For the purposes of this specification, if there is any inconsistency in the language between this specification and the language in one or more of these documents, the language in this specification prevails.

### FIELD OF THE INVENTION

The present invention relates to additive manufacturing in general, and, more particularly, to an additive manufacturing process that uses segments of fiber-reinforced thermoplastic feedstock (e.g., pre-preg tape, filament, etc.) as its elemental unit of fabrication.

### BACKGROUND OF THE INVENTION

In the same way that a building can be constructed by successively depositing bricks on top of one another, it is well known in the field of additive manufacturing that an article of manufacture can be fabricated by successively depositing segments of fiber-reinforced thermoplastic filament on top of one another.

In some ways, a segment of thermoplastic filament is similar to a spaghetti noodle. When the temperature of a thermoplastic filament is below its resin softening point, the filament is long, thin, stiff, and not sticky—like a dry spaghetti noodle. In contrast, when the temperature of the filament is above its resin softening point but below its melting point, the filament is long, thin, flexible, and sticky—like a wet spaghetti noodle.

There are, however, some key differences between bricks and thermoplastic filament. For example, masonry bricks are not, in and of themselves, self-adhesive, and, therefore an adhesive compound—typically mortar—is used to bind them together. In contrast, segments of thermoplastic filaments are self-adhesive, and they will become bound if they are pressed tightly when they are hot and held together until they are cool.

Similarly, it is well known in the field of additive manufacturing that an article of manufacture can be fabricated by successively depositing segments of thermoplastic tape on top of one another. Whereas a segment of thermoplastic filament is similar to spaghetti, a segment of thermoplastic tape is similar to a ribbon pasta or lasagna noodle. When the temperature of the thermoplastic tape is below its resin softening point, the tape is long, thin, wide, stiff, and not tacky—like a dry lasagna noodle. In contrast, when the temperature of the tape is above its resin softening point but below its melting point, the tape is long, thin, wide, flexible, and sticky—like a wet lasagna noodle. And like thermoplastic filament, segments of thermoplastic tape are self-adhesive, and they will become bound if they are pressed tightly when they are hot and held together until they are cool.

FIG. 1 depicts an illustration of additive manufacturing system 100 in the prior art, which system fabricates articles of manufacture by successively depositing segments of fiber-reinforced thermoplastic feedstock (e.g., filament, tape, etc.) on top of one another.

Additive manufacturing system 100 comprises: platform 101, robot mount 102, robot 103, build plate support 104, build plate 105, workpiece 106, deposition head 107, tamping tool 108, controller 109, feedstock reel 110, feedstock 111, accumulator 112, laser 141, optical cable 151, optical instrument 161, laser beam 171, laser control cable 191, irradiated region 271, nip line segment 281, pinch line segment 282, and deposition path 291, interrelated as shown.

FIG. 2a depicts a close-up of workpiece 106, deposition head 107, tamping tool 108, feedstock 111, optical cable 151, optical instrument 161, and laser beam 171, as shown in FIG. 1. FIG. 2b depicts a close-up of workpiece 106, deposition head 107, tamping tool 108, feedstock 111, irradiated region 271, and deposition path 291, along cross-section AA-AA, as shown in FIG. 2a. FIG. 3 depicts a schematic diagram of the heating architecture for additive manufacturing system 100.

Platform 101 is a rigid metal structure that ensures that the relative spatial relationship of robot mount 102, robot 103, deposition head 107 (including tamping tool 108), and optical instrument 161 are maintained and known with respect to build-plate support 104, build plate 105, and workpiece 106. Robot mount 102 is a rigid, massive, and stable support for robot 103 that provides ballast and inertial stability for robot 103. Robot 103 is a six-axis articulated mechanical arm that holds deposition head 107, optical instrument 161 and optical cable 151. The movement of robot 103 (including deposition head 107) is under the direction of controller 109. Robot 103 is capable of depositing feedstock 111 at any location, in any one-, two-, or three-dimensional curve, and with any angular orientation.

Build plate support 104 is a rigid, massive, and stable support for build plate 105 and workpiece 106. Build plate support 104 comprises a stepper motor—under the direction of controller 109—that is capable of rotating build plate 105 (and, consequently workpiece 106) around an axis that is normal to the X-Y plane. Build plate 105 is a rigid aluminum-alloy support onto which workpiece 106 is steadfastly affixed so that workpiece 106 cannot move in any direction or rotate around any axis independently of build plate 105. Workpiece 106 comprises one or more segments of feedstock 111 that have been successively deposited and welded together in a desired geometry. Deposition head 107 is the end effector of robot 103 and comprises:
(i) a feedstock guide that directs feedstock 111 into position for heating, tamping, and welding onto workpiece 106, and
(ii) tamping tool 108, which tamps the heated feedstock 111 into the heated workpiece 106, and
(iii) a feedstock cutter—under the direction of controller 109—that periodically or sporadically cuts feedstock 111, and
(iv) optical instrument 161, which takes laser beam 171 from optical cable 151, conditions it, and directs it onto irradiated region 271, and
(v) a structural support for optical instrument 161 that maintains the relative spatial position of the feedstock guide, tamping tool 108, the cutter, and optical instrument 161.

The feedstock guide, the feedstock cutter, and the structural support for optical instrument 161 are omitted from the figures so that the reader can more clearly understand the functional and spatial relationship of workpiece 106, deposition head 107, tamping tool 108, feedstock 111, and optical instrument 161.

Tamping tool 108 comprises a roller-bearing mounted steel cylinder that tamps the heated feedstock 111 into the heated workpiece 106.

Controller 109 comprises the hardware and software necessary to direct robot 103, build plate support 104, and deposition head 107 in order to fabricate the article of manufacture.

Feedstock reel 110 is a circular reel that stores 1000 meters of feedstock 111 and feeds that feedstock to deposition head 107 and that maintains a constant tension on feedstock 111. Feedstock 111 is a carbon fiber-reinforced thermoplastic filament or tape, which is commonly called “pre-preg.” Accumulator 112 takes feedstock 111 from feedstock reel 110 and provides it to deposition head 107 with the correct tension for depositing.

Optical instrument 161 is hardware that takes high-intensity laser beam from optical cable 151 and outputs laser beam 171, which illuminates and heats those portions of feedstock 111 and workpiece 106 that are within irradiated region 271. Laser 141 is a high-power laser whose output power is controlled by controller 109, via laser control cable 191. Because controller 109 controls robot 103 and the speed at which feedstock 111 is deposited, controller 109 knows how quickly or slowly each unit-length of feedstock 111 must be heated and adjusts laser 141 accordingly. When the feedstock is deposited quickly, laser 141 is set to higher power so that feedstock 111 and workpiece 106 can be heated quickly. In contrast, when feedstock 111 is deposited more slowly, laser 141 is set to lower power, and when deposition stops laser 141 is turned off. Optical cable 151 is a glass fiber for carrying the light from laser 141 to optical instrument 161 with substantially no loss.

Nip line segment 281 is that line segment on the circumferential surface of tamping tool 108 where the compressive force on feedstock 111 from tamping tool 108 and workpiece 106 is at a maximum. Pinch line segment 282 is that line segment on the circumferential surface of tamping tool 108 where the compressive force on feedstock 111 from tamping tool 108 and workpiece 106 first substantially constrains any movement of feedstock 111 parallel to the axis of tamping tool 108.

Deposition path 291 depicts the location on workpiece 106 where feedstock 111 is next to be deposited.

In this context, the process of fabricating articles of manufacture with segments of fiber-reinforced thermoplastic feedstock presents many challenges.

### SUMMARY OF THE INVENTION

Some embodiments of the present invention art are capable of welding feedstock to a workpiece without some of the costs and disadvantages for doing so in the prior art. The nature of these costs and disadvantages becomes clear upon close examination of additive manufacturing system 100, as presented above and in FIGS. 1, 2a, 2b, and 3.

The job of laser beam 171 is to heat each segment of feedstock 111—and the corresponding portion of workpiece 106 to which it is to be welded—to a very narrow temperature range above their resin softening point. If the temperature of either is too low, then the weld will be defective, and if the temperature of either is too high, then it could burn or melt.

In the prior art, laser beam 171 heats both workpiece 106 and feedstock 111 at the same time, in the same manner, and with the beam's energy evenly split between them. Given that both workpiece 106 and feedstock 111 comprise the same material and must be heated to the same temperature, the use of laser beam 171 to heat them both appears to be reasonable. In practice, however, it fails to produce quality welds, and on close examination, the reason why is clear: the task of heating the workpiece is, in general, far more complex and variable than the task of heating the feedstock.

The geometry and composition of each unit-length of feedstock 111 is approximately uniform, and, therefore, each unit-length of feedstock 111 has approximately the same surface area, heat capacity, and thermal conductivity as every other segment. As long as the initial temperature of each segment is the same, then the same amount of heat energy is needed to heat each segment to its resin softening point.

In contrast, the geometry and fiber orientation of each portion of workpiece 106 varies, and, therefore, different portions of workpiece 106 have different surface areas, heat capacities, and thermal conductivities. As a result, different portions of workpiece 106 require different amounts of heat energy to heat them to their resin softening point.

Furthermore, laser beam 271 needs to heat those portions of workpiece 106 along deposition path 291. When deposition path 291 is straight, laser beam 271 heats the correct portions, but when deposition path 291 twists and turns—as shown in FIG. 2b—laser beam 271 does not heat the correct portions.

And still furthermore, the angle of incidence of laser beam 271 on feedstock 111 is generally consistent, which causes each unit-length of feedstock to absorb the same amount of heat energy per unit-time. In contrast, the angle of incidence of laser beam 271 on workpiece 106 is inconsistent because of variations in the contour of workpiece 106. This, in turn, causes:
(i) the irradiance of laser beam 171 at each unit-area on workpiece 106 to vary, and
(ii) the amount of light that is reflected off of workpiece 106 to vary, and
(iii) the amount of light that is refracted into—and absorbed by—workpiece 106 to vary, and
(iv) different unit-areas of workpiece 106 to absorb different amounts of heat energy per unit-time.

To address these and other issues, the illustrative embodiment comprises two independent but coordinated laser/optical instrument pairs:
(i) a feedstock laser and feedstock optical instrument pair that are solely dedicated to heating the feedstock, and
(ii) a workpiece laser and workpiece optical instrument pair that are solely dedicated to heating the workpiece.

This is advantageous because it enables one pair to be tailored to addressing the particular issues associated with heating the feedstock, and the second pair to be tailored to addressing the particular issues associated with heating the workpiece.

The feedstock laser and the feedstock optical instrument are both controlled by a controller that employs feedforward, a variety of sensors, and feedback to ensure that each segment of feedstock is properly heated. To this end, the controller continually moderates the amount of heat energy presented to each segment by:
(i) directing the feedstock laser to adjust the power of the filament laser beam, and
(ii) directing the feedstock optical instrument to adjust the length of feedstock that is irradiated and heated.

The feedstock optical instrument adjusts the length of feedstock that is irradiated and heated by:
(i) shaping the feedstock laser beam so that it has an elliptical beam energy isocline, and
(ii) rotating the feedstock laser beam, under the direction of the controller, to moderate how much heat energy is presented to the feedstock.

This is depicted in FIGS. 14, 15, and 16. For example, when the laser beam is rotated to an angle of rotation of θ=0° (the major axis of the elliptical beam energy isocline is parallel with the feedstock as shown in FIG. 14), the longest length of filament is irradiated and heated. In contrast, when the laser beam is rotated to at an angle of rotation of θ=−90° (the major axis of the elliptical beam energy isocline is perpendicular with the feedstock as shown in FIG. 16), the shortest length of feedstock is irradiated and heated. The illustrative embodiment is capable of continually adjusting the angle of rotation θ of the laser beam to any angle between 0° and −90° (as shown in FIG. 17), and, therefore, of adjusting the length of feedstock that is irradiated.

To this end, the illustrative embodiment comprises: rotating a laser beam around an axis of rotation from a first angle to a second angle, wherein the first angle does not equal the second angle; irradiating and heating a first segment of a filament with at least a first portion of the laser beam at the second angle during a first time-interval; depositing and tamping the first segment of the filament onto a first portion of a workpiece during a second time-interval, wherein the second time-interval is after, and mutually exclusive of, the first time-interval; rotating the laser beam around the axis of rotation from the second angle to a third angle, wherein the second angle does not equal the third angle; irradiating and heating a second segment of the filament with at least a second portion of the laser beam at the third angle during a third time-interval, wherein the third time-interval is after, and mutually exclusive of, the first time-interval; and depositing and tamping the second segment of the filament onto a second portion of the workpiece during a fourth time-interval, wherein the fourth time-interval is after, and mutually exclusive of, the third time-interval; wherein the laser beam has an anisotropic beam energy isocline with respect to the axis of rotation.

The workpiece laser and the workpiece optical instrument are also both controlled by the controller, which employs feedforward, the variety of sensors, and feedback to ensure that the correct portion of the workpiece is heated and that it is properly heated. To this end, the controller continually:
(i) directs the workpiece optical instrument to steer the workpiece laser beam onto the portion of the workpiece associated with the deposition path, and
(ii) directs the workpiece laser to adjust the power of the workpiece laser beam.

The workpiece optical instrument steers the workpiece laser beam by:
(i) shaping the workpiece laser beam so that it has an elliptical beam energy isocline, and
(ii) rotating the workpiece laser beam, under the direction of the controller, to put the workpiece laser beam onto the deposition path.

This is depicted in FIGS. 20, 21, and 22. For example, when the deposition path is straight (as shown in FIG. 20), the laser beam is rotated around the axis of rotation so that the beam axis intersects the deposition path. In contrast, when the deposition path is not straight (as shown, for example and without limitation in FIGS. 21 and 22), the laser beam is rotated around the axis of rotation so that the beam axis intersects the deposition path. The illustrative embodiment is capable of continually adjusting the angle of rotation θ of the laser beam to any angle between −90° and +90° (as shown in FIG. 23), and, therefore, of steering the laser beam onto the deposition path however it twists and turns.

To this end, the illustrative embodiment comprises: steering a laser beam from a first portion of a workpiece to a second portion of the workpiece by rotating the laser beam around an axis of rotation, wherein second portion of the workpiece is based on a location of a first length of a deposition path with respect to the workpiece, and wherein the first portion of the workpiece and the second portion of the workpiece are not the same; irradiating and heating the second portion of a workpiece with the laser beam during a first time-interval; and depositing and tamping a first segment of a filament onto the second portion of the workpiece during a second time-interval, wherein the second time-interval is after, and mutually exclusive of, the first time-interval.

### BRIEF DESCRIPTION OF THE DRAWINGS

FIG. 1 depicts an illustration of additive manufacturing system 100 in the prior art, which system fabricates articles of manufacture by successively depositing segments of fiber-reinforced thermoplastic feedstock (e.g., filament, tape, etc.) on top of one another.

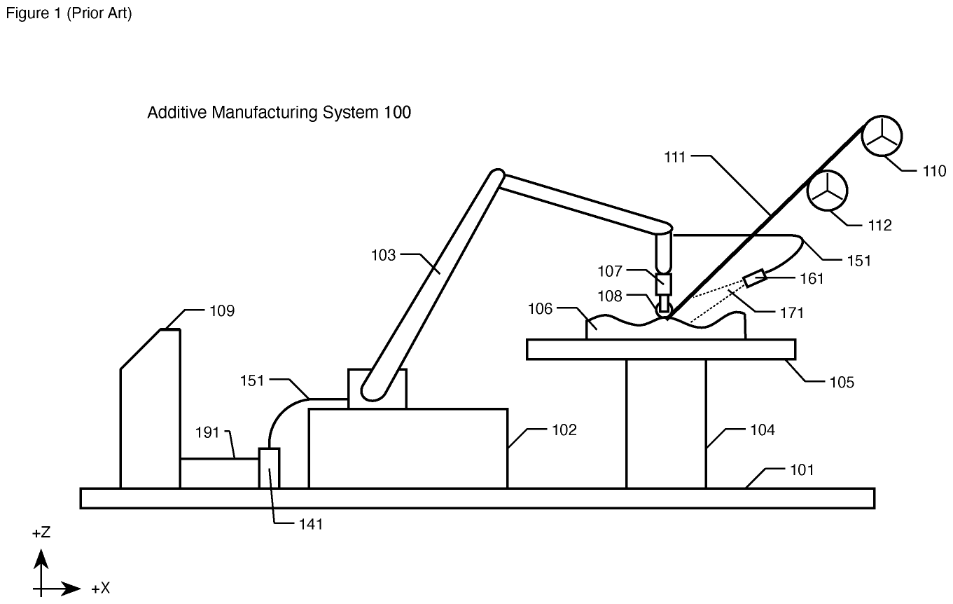

FIG. 2a depicts a close-up of workpiece 106, deposition head 107, tamping tool 108, feedstock 111, optical cable 151, optical instrument 161, and laser beam 171, as shown in FIG. 1.

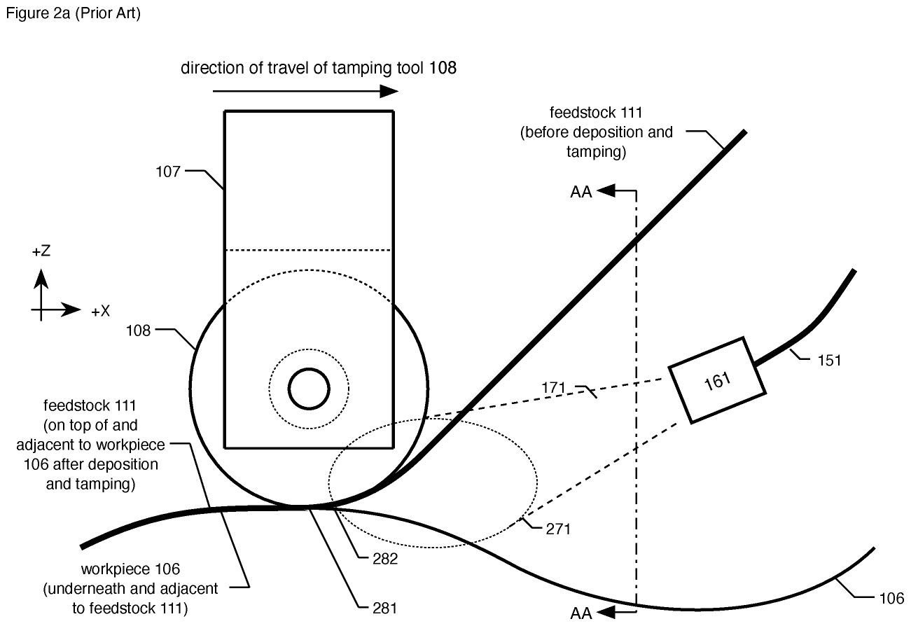

FIG. 2b depicts a close-up of workpiece 106, deposition head 107, tamping tool 108, and feedstock 111 along cross-section AA-AA, as shown in FIG. 2a.

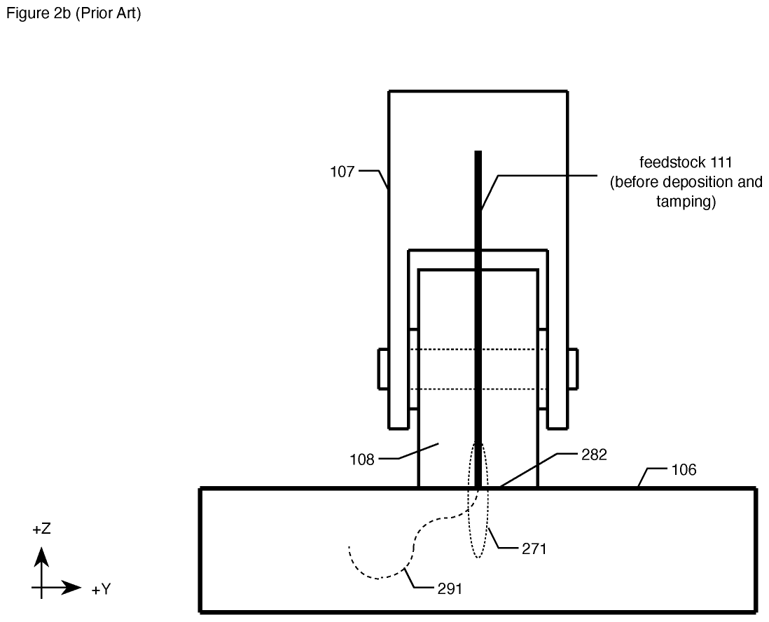

FIG. 3 depicts a schematic diagram of the heating architecture for additive manufacturing system 100.

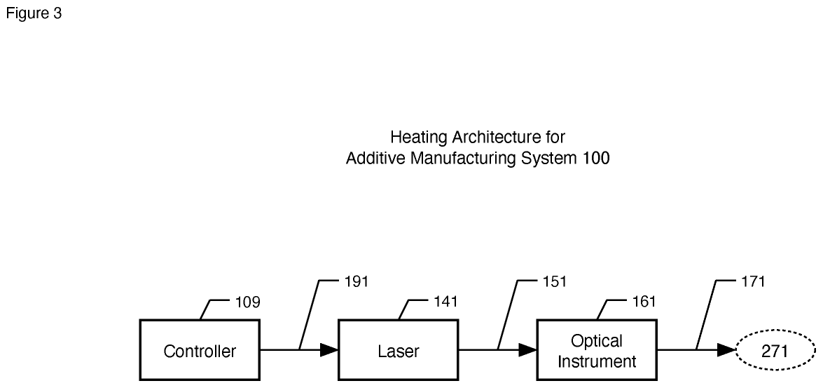

FIG. 4 depicts an illustration of additive manufacturing system 400 in accordance with the illustrative embodiment of the present invention.

FIG. 5a depicts a close-up of workpiece 406, deposition head 407, tamping tool 408, feedstock 411, sensor array 415, optical instrument 461, optical instrument 462, optical cable 451, optical cable 452, sensor cable 454, laser beam 471, laser beam 472, feedstock region 571-1, feedstock region 571-2, feedstock region 571-3, workpiece region 572-1, workpiece region 572-2, workpiece region 572-3, nip line segment 581, and pinch line segment 582, interrelated as shown.

FIG. 5b depicts a close-up of workpiece 406 in which deposition path 591 curves to the right (from the perspective of deposition head 407).

FIG. 6 depicts a close-up of workpiece 406 in which deposition path 591 curves to the left (from the perspective of deposition head 407).

FIG. 7 depicts a schematic diagram of the heating and sensor architecture for additive manufacturing system 400, which irradiates and heats feedstock 411 and workpiece 406 and measures the temperature of feedstock 411 and workpiece 406.

FIG. 8 depicts a schematic diagram of the sensor and control architecture for that portion of additive manufacturing system 400 that irradiates and heats feedstock 411 and workpiece 406.

FIG. 9 depicts a flowchart of the tasks performed by additive manufacturing system 400. Because additive manufacturing system 400 concurrently performs tasks on different segments of feedstock 411 and different portions of workpiece 406, the tasks depicted in FIG. 9 are concurrent.

FIG. 10 depicts a flowchart of the details of task 907—adjusting optical instrument 461 and optical instrument 462, as directed by controller 409.

FIG. 11 depicts a flowchart of the relative timing of the tasks performed on segment m of feedstock 411 and on portion n of workpiece 406, wherein m and n are integers. In accordance with the illustrative embodiment segment m of feedstock 411 is deposited and tamped onto portion n of workpiece 406.

FIG. 12a depicts a front orthographic representation of optical instrument 461 in accordance with the illustrative embodiment of the present invention.

FIG. 12b depicts a side orthographic representation of optical instrument 461.

FIG. 12c depicts a front orthographic representation of optical instrument 461 along cross-section CC-CC.

FIG. 12d depicts a top orthographic representation of optical instrument 462 along cross-section DD-DD.

FIG. 13 depicts beam energy isocline 1203 at cross-section EE-EE (which is normal to axis of rotation 1201), approximately 200 mm from cylindrical lens 1212-2, and with laser beam 471 at an angle of rotation of θ=0°.

FIG. 14 depicts laser beam 471—with an angle of rotation of θ=0° and an angle of incidence of φ=30°—as is projected onto the feedstock plane.

FIG. 15 depicts laser beam 471—with an angle of rotation of θ=−15° and an angle of incidence of φ=30°—as is projected onto the feedstock plane.

FIG. 16 depicts laser beam 471—with an angle of rotation of θ=−90° and an angle of incidence of φ=30°—as is projected onto the feedstock plane.

FIG. 17 depicts the full range of motion of beam energy isocline 1203 at cross-section EE-EE, with angles of rotation θ from 0° to −90°.

FIG. 18a depicts a front orthographic representation of optical instrument 462 in accordance with the illustrative embodiment of the present invention.

FIG. 18b depicts a side orthographic representation of optical instrument 462.

FIG. 18c depicts a front orthographic representation of optical instrument 462 along cross-section FF-FF.

FIG. 18d depicts a top orthographic representation of optical instrument 462 along cross-section GG-GG.

FIG. 19 depicts the shape of laser beam 472 at cross-section HH-HH (which is normal to beam axis 1802), approximately 200 mm from cylindrical lens 1812-2, and wherein laser beam 472 is at an angle of rotation of θ=0°.

FIG. 20 depicts the shape of laser beam 472, with an angle of rotation of θ=0°, as it irradiates workpiece region 572-2 along a straight length of deposition path 591.

FIG. 21 depicts the shape of laser beam 472, with an angle of rotation of θ=−27°, as it irradiates workpiece region 572-2 along a length of deposition path 591 that curves to the right (from the perspective of pinch line segment 582).

FIG. 22 depicts the shape of laser beam 472, with an angle of rotation of θ=+27°, as it irradiates workpiece region 572-2 along a length of deposition path 591 that curves to the left (from the perspective of pinch line segment 582).

FIG. 23 depicts the range of motion of laser beam 472 around axis of rotation 1801, which is continuous from −90° to +90°.

### DEFINITIONS

Angle of Incidence—For the purposes of this specification, the term “angle of incidence” is defined as the actual angle between a line and a plane. This is in contrast to how the term is used in some as the angle between a line and a second line normal to the plane.

Beam energy isocline—For the purposes of this specification, the term “beam energy isocline” is defined as a planar isocline that encloses a specific percentage of the energy in a laser beam.

Irradiance—For the purposes of this specification, the term “irradiance” is defined as the radiant flux received by a surface per unit-area. The SI unit of irradiance is the Watt per meter².

Nip line segment—For the purposes of this specification, a “nip line segment” on a tamping tool is defined as line segment on the circumferential surface of the tamping tool where the tamping tool exerts the maximum radial force on a feedstock.

Pinch line segment—for the purposes of this specification, a “pinch line segment” on a tamping tool is defined as the line segment on the circumferential surface of the tamping tool where the tamping tool first pinches a unit-length of feedstock between the tamping tool and the workpiece so that any movement of the feedstock parallel to the rotational axis of the tamping tool is substantially constrained.

Printer—For the purposes of this specification, a “printer” is defined as an additive manufacturing system or an additive and subtractive manufacturing system.

Printing—For the purposes of this specification, the infinitive “to print” and its inflected forms is defined as to fabricate. The act of fabrication is widely called “printing” in the field of additive manufacturing.

Resin Softening Point—For the purposes of this specification, the phrase “resin softening point” is defined as the temperature at which the resin softens beyond some arbitrary softness.

Touch Line Segment—For the purposes of this specification, a “touch line segment” on a tamping tool is defined as the line segment on the circumferential surface of the tamping tool where the tamping tool first touches a unit-length of feedstock. The force of the tamping tool on the feedstock at the touch line segment is infinitesimal.

Workpiece—For the purposes of this specification, a “workpiece” is defined as an inchoate article of manufacture.

### DETAILED DESCRIPTION

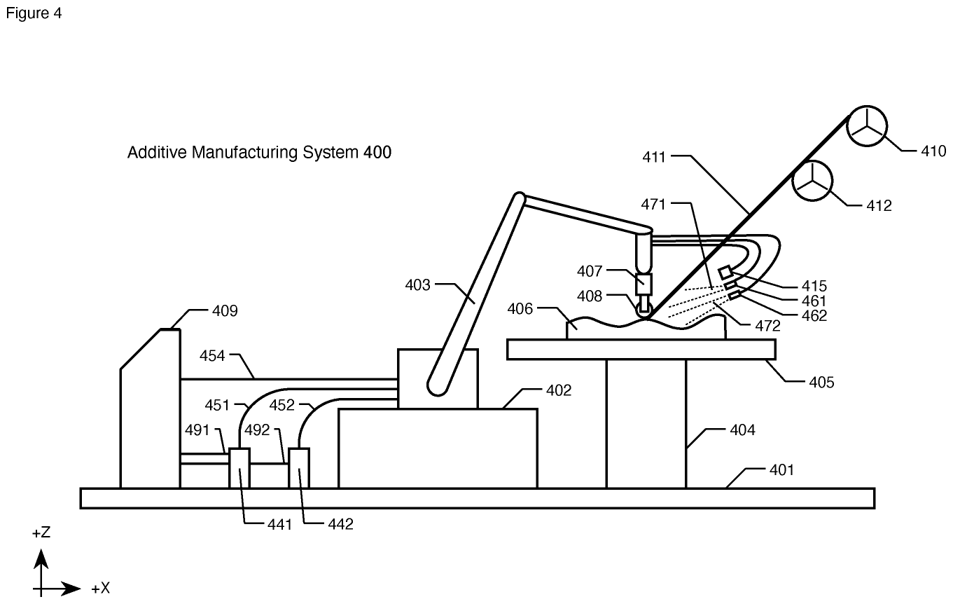

FIG. 4 depicts an illustration of additive manufacturing system 400 in accordance with the illustrative embodiment of the present invention. Additive manufacturing system 400 fabricates an article of manufacture by successively depositing segments of fiber-reinforced thermoplastic feedstock (e.g., filament, tape, etc.) onto a workpiece until the article of manufacture is complete.

Additive manufacturing system 400 comprises: platform 401, robot mount 402, robot 403, build plate support 404, build plate 405, workpiece 406, deposition head 407, tamping tool 408, controller 409, feedstock reel 410, feedstock 411, accumulator 412, force gauge 413, sensor array 415, feedstock laser 441, workpiece laser 442, optical cable 451, optical cable 452, sensor cable 454, optical instrument 461, optical instrument 462, laser beam 471, laser beam 472, feedstock laser control cable 491, and workpiece laser control cable 492, interrelated as shown.

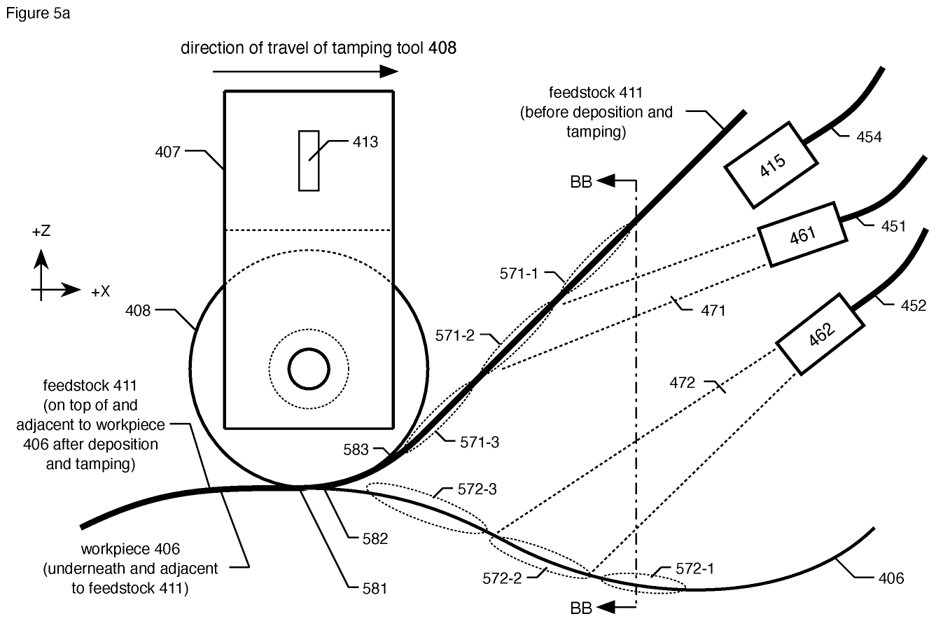

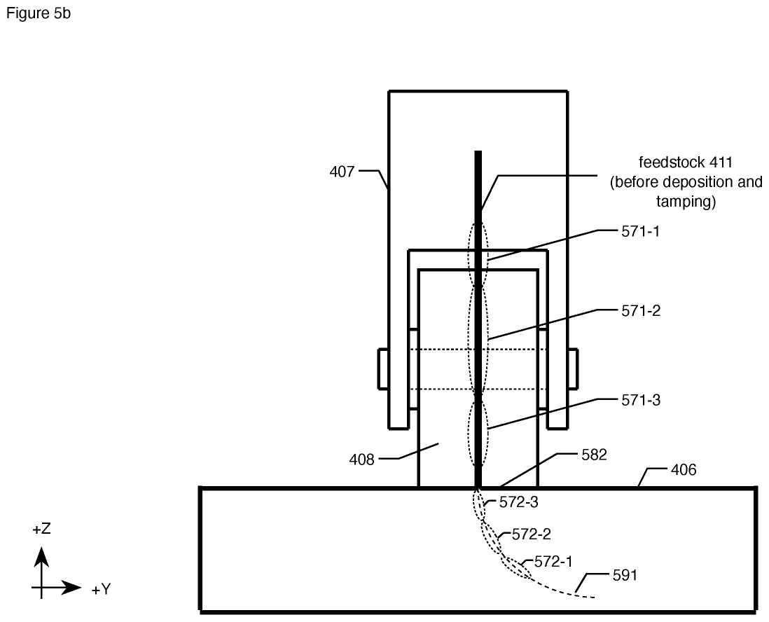

FIG. 5a depicts a close-up of workpiece 406, deposition head 407, tamping tool 408, feedstock 411, sensor array 415, optical instrument 461, optical instrument 462, optical cable 451, optical cable 452, sensor cable 454, laser beam 471, laser beam 472, feedstock region 571-1, feedstock region 571-2, feedstock region 571-3, workpiece region 572-1, workpiece region 572-2, workpiece region 572-3, nip line segment 581, pinch line segment 582, and touch line segment 583, interrelated as shown.

FIG. 5b depicts a close-up of workpiece 406, deposition head 407, tamping tool 408, feedstock 411, feedstock region 571-1, feedstock region 571-2, feedstock region 571-3, workpiece region 572-1, workpiece region 572-2, workpiece region 572-3, pinch line segment 582, and deposition path 591 all as seen along cross-section BB-BB as shown in FIG. 5a.

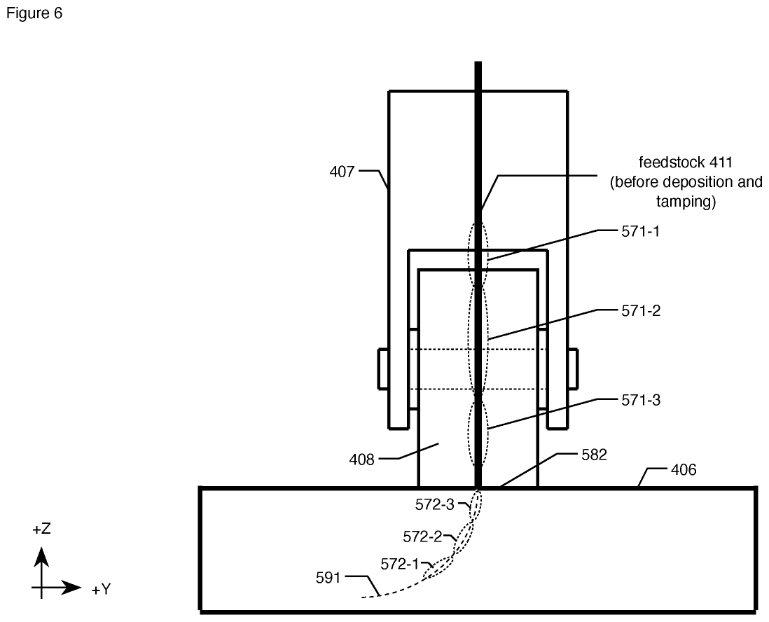

FIG. 6 depicts a close-up of workpiece 406, deposition head 407, tamping tool 408, feedstock 411, feedstock region 571-1, feedstock region 571-2, feedstock region 571-3, workpiece region 572-1, workpiece region 572-2, workpiece region 572-3, pinch line segment 582, and deposition path 591, all as seen along cross-section BB-BB as shown in FIG. 5a.

FIG. 6 differs from FIG. 5a in that the curvature of deposition path 591 in FIG. 5a curves to the right (from the perspective of deposition head 407) whereas deposition path 591 in FIG. 6 curves to the left. This is because additive manufacturing system 400 steers laser beam 472, workpiece region 572-1, workpiece region 572-2, and workpiece region 572-3 onto deposition path 591 as deposition path 591 meanders on workpiece 406.

Platform 401 is a rigid metal structure and is identical to platform 101 in the prior art. Platform 401 ensures that the relative spatial relationship of robot mount 402, robot 403, deposition head 407, tamping tool 408, optical instrument 461, optical instrument 462, and sensor array 415 are maintained and known with respect to build-plate support 404, build plate 405, workpiece 406, and deposition path 591. It will be clear to those skilled in the art how to make and use platform 401.

Robot mount 402 is a rigid, massive, and stable support for robot 403 and is identical to robot mount 102 in the prior art. The purpose of robot mount 402 is to provide ballast and inertial stability for robot 403. It will be clear to those skilled in the art how to make and use robot mount 402.

Robot 403 is a six-axis articulated mechanical arm that supports deposition head 407, tamping tool 408, optical instrument 461, optical instrument 462, sensor array 415, optical cable 451, optical cable 452, and sensor cable 454. Robot 403 is identical to robot 103 in the prior art. It will be clear to those skilled in the art, however, after reading this disclosure, how to make and use alternative embodiments of the present invention in which a different type of robot (e.g., a cartesian robot, a cylindrical robot, a SCARA, a delta robot, etc.) is used. A non-limiting example of robot 403 is the IRB 4600 robot offered by ABB. The motion of robot 403 is under the direction of controller 409, and robot 403 is capable of depositing feedstock 411 at any location on workpiece 406 and in any one-, two-, or three-dimensional curve. It will be clear to those skilled in the art how to make and use robot 403.

Build plate support 404 is a rigid, massive, and stable support for build plate 405 and workpiece 406 and is identical to build plate support 104 in the prior art. The purpose of build plate support 404 is to provide ballast and inertial stability for build plate 405 and also to provide a mechanism for rotating build plate 405 around an axis that is normal to the X-Y plane. To wit, build plate support 404 comprises a stepper motor—under the direction of controller 409—that is capable of rotating build plate 405 (and, consequently workpiece 406) around an axis that is normal to the X-Y plane. It will be clear to those skilled in the art how to make and use build plate support 404.

Build plate 405 is a rigid aluminum-alloy support and is described in detail in U.S. patent application Ser. No. 16/792,156, entitled “Thermoplastic Mold with Implicit Registration,” filed on Feb. 14, 2020 (Attorney Docket 3019-245us1), and incorporated by reference for the purpose of describing build plate 405. The purpose of build plate 405 is to provide support for workpiece 406 (and a mold with a tunably adhesive surface for workpiece 406). U.S. patent application Ser. No. 16/792,150, entitled “Thermoplastic Mold with Tunable Adhesion,” filed on Feb. 14, 2020 (Attorney Docket 3019-243us1) is also incorporated by reference for the purpose of describing the interface between build plate 405 and workpiece 4066. It will be clear to those skilled in the art how to make and use build plate 405 after reading this disclosure and the incorporated patent applications.

Workpiece 406 comprises a plurality of segments of feedstock 411 that have been successively deposited and welded together in a desired geometry to form the inchoate article of manufacture. Workpiece 406 is steadfastly affixed to build plate 405 so that workpiece 406 cannot move or rotate independently of build plate 405.

Deposition head 407 is the end effector of robot 403 and comprises:
(i) a feedstock guide that feeds feedstock 411 into position for heating, tamping, and welding to workpiece 406. The feedstock guide is omitted from the figures for clarity but is described in U.S. Pat. No. 10,076,870, entitled “Filament Guide,” issued on Sep. 18, 2018 (Attorney Docket 3019-142us1), which is incorporated by reference.
(ii) tamping tool 408, which first pinches and then tamps each segment of feedstock 411 onto the corresponding portion of workpiece 406.
(iii) force gauge 413 that continually measures the force of tamping tool 408 on feedstock 411 at nip line segment 581 and reports those measurements back to controller 409 via sensor cable 454.
(iv) a feedstock cutter—under the direction of controller 409—that periodically or sporadically cuts feedstock 411. The feedstock cutter is omitted from the figures for clarity but is described in U.S. patent application Ser. No. 16/023,197, entitled “Filament Cutter,” filed on Jun. 29, 2018 (Attorney Docket 3019-161us1 ARVO 7926), which is incorporated by reference.
(v) optical instrument 461, which takes laser beam 471 from optical cable 451, and—under the direction of controller 409—conditions laser beam 471 and directs it onto feedstock region 571-2.
(vi) optical instrument 462, which takes laser beam 472 from optical cable 452, and—under the direction of controller 409—conditions laser beam 472 and directs it onto workpiece region 572-2.
(vii) sensor array 415, which measures the temperature of feedstock region 571-2, workpiece region 572-2, and tamping tool 408 and reports those measurements to controller 409 via sensor cable 454.
(viii) structural support for optical instrument 461, optical instrument 462, and sensor array 415 and that maintains the relative spatial location and position of the feedstock guide, tamping tool 408, pinch line segment 582, the cutter, optical instrument 461, optical instrument 462, and sensor array 415. The structural support is omitted from the figures for clarity but it will be clear to those skilled in the art, after reading this disclosure, how to make and use the structural support.

It will be clear to those skilled in the art, after reading this disclosure, how to make and use deposition head 407.

Tamping tool 408 comprises a roller-bearing mounted steel cylinder (roller) whose tangential speed equals the linear speed of the feedstock adjacent to the roller (i.e., tamping tool 408 rotates freely and there is substantially no friction between tamping tool 408 and feedstock 411. It will be clear to those skilled in the art how to make and use tamping tool 408.

The following patent applications disclose designs for tamping tool 408, which are alternatives to the roller-bearing mounted steel cylinder:
(i) U.S. patent application Ser. No. 15/959,213, entitled “Variable-Contour Compaction Press,” filed on Apr. 21, 2018 (Attorney Docket 3019-171us1); and
(ii) U.S. patent application Ser. No. 15/959,214, entitled “Variable-Contour Compaction Roller,” filed on Apr. 21, 2018 (Attorney Docket 3019-172us1); and
(iii) U.S. patent application Ser. No. 15/959,215, entitled “Self-Cleaning Variable-Contour Compaction Press,” filed on Apr. 21, 2018 (Attorney Docket 3019-173us1);
   each of which is incorporated by reference.

Controller 409 comprises the hardware and software necessary to control all aspects of fabricating the article of manufacture, including, but not limited to:
(i) robot 403 (which includes the location and motion of tamping tool 408), and
(ii) build plate support 404, and
(iii) the feedstock cutter, and
(iv) feedstock laser 441, and
(v) workpiece laser 442, and
(vi) optical instrument 461, and
(vii) optical instrument 462, and
(viii) accumulator 412.

To accomplish this controller 409 relies on a combination of feedforward and feedback, as described in detail below and in the accompanying drawings. It will be clear to those skilled in the art, after reading this disclosure, how to make and use controller 409.

Feedstock reel 410 is a circular reel that stores 1000 meters of feedstock 411. Feedstock real 410 feeds feedstock 411 to accumulator 412. It will be clear to those skilled in the art how to make and use feedstock reel 410.

Feedstock 411 is a carbon fiber-reinforced thermoplastic filament, which is commonly called “pre-preg.” It will be clear to those skilled in the art, however, after reading this disclosure, how to make and use alternative embodiments of the present invention in which the feedstock is a fiber-reinforced pre-preg tape—woven or uni-directional—that is impregnated with thermoplastic resin.

Feedstock 411 comprises cylindrical towpreg of contiguous 12K carbon fiber that is impregnated with thermoplastic resin. The cross-section is circular and has a diameter of 1000 μm. It will be clear to those skilled in the art, however, after reading this disclosure, how to make and use alternative embodiments of the present invention in which the cross-section of the filament is a quadrilateral (e.g., a square, a rectangle, a rhombus, a trapezoid, a kite, a parallelogram, etc.). Furthermore, it will be clear to those skilled in the art how to make and use alternative embodiments of the present invention in which feedstock 411 comprises a different number of fibers (e.g., 1K, 3K, 6K, 24K, etc.). And still furthermore, it will be clear to those skilled in the art how to make and use alternative embodiments of the present invention in which the fibers in feedstock 111 are made of a different material (e.g., fiberglass, aramid, carbon nanotubes, etc.).

In accordance with the illustrative embodiment, feedstock 411 comprises continuous carbon fiber, but it will be clear to those skilled in the art how to make and use alternative embodiments of the present invention in which feedstock 411 comprises chopped or milled fiber.

In accordance with the illustrative embodiments, the thermoplastic in feedstock 411 is, in general, a semi-crystalline polymer and, in particular, the polyaryletherketone (PAEK) known as polyetherketone (PEK). In accordance with some alternative embodiments of the present invention, the semi-crystalline material is the polyaryletherketone (PAEK), polyetheretherketone (PEEK), polyetherketoneketone (PEKK), polyetheretherketoneketone (PEEKK), or polyetherketoneetherketoneketone (PEKEKK). As those who are skilled in the art will appreciate after reading this disclosure, the disclosed annealing process, as it pertains to a semi-crystalline polymer in general, takes place at a temperature that is above the glass transition temperature Tg.

In accordance with some alternative embodiments of the present invention, the semi-crystalline polymer is not a polyaryletherketone (PAEK) but another semi-crystalline thermoplastic (e.g., polyamide (PA), polybutylene terephthalate (PBT), poly(p-phenylene sulfide) (PPS), etc.) or a mixture of a semi-crystalline polymer and an amorphous polymer.

When feedstock 411 comprises a blend of an amorphous polymer with a semi-crystalline polymer, the semi-crystalline polymer can one of the aforementioned materials and the amorphous polymer can be a polyarylsulfone, such as polysulfone (PSU), polyethersulfone (PESU), polyphenylsulfone (PPSU), polyethersulfone (PES), or polyetherimide (PEI). In some additional embodiments, the amorphous polymer can be, for example and without limitation, polyphenylene oxides (PPOs), acrylonitrile butadiene styrene (ABS), methyl methacrylate acrylonitrile butadiene styrene copolymer (ABSi), polystyrene (PS), or polycarbonate (PC). As those who are skilled in the art will appreciate after reading this disclosure, the disclosed annealing process, as it pertains to a blend of an amorphous polymer with a semi-crystalline polymer, takes place generally at a lower temperature than a semi-crystalline polymer with the same glass transition temperature; in some cases, the annealing process can take place at a temperature slightly below the glass transition temperature.

When the feedstock comprises a blend of an amorphous polymer with a semi-crystalline polymer, the weight ratio of semi-crystalline material to amorphous material can be in the range of about 50:50 to about 95:05, inclusive, or about 50:50 to about 90:10, inclusive. Preferably, the weight ratio of semi-crystalline material to amorphous material in the blend is between 60:40 and 80:20, inclusive. The ratio selected for any particular application may vary primarily as a function of the materials used and the properties desired for the printed article.

In some alternative embodiment of the present invention, the feedstock comprises a metal. For example, and without limitation, the feedstock can be a wire comprising stainless steel, Inconel (nickel/chrome), titanium, aluminum, cobalt chrome, copper, bronze, iron, precious metals (e.g., platinum, gold, silver, etc.).

In accordance with the illustrative embodiment, the thermoplastic is infused with carbon nano-particles, the purpose of which is two-fold. First, the carbon nano-particles facilitate the absorption of radiant heat from laser beam 471 and laser beam 472. Second, the carbon nano-particles effectively change the reactance of the thermoplastic, which makes the completed article of manufacture more conducive to electro-static powder coating.

Accumulator 412 takes feedstock 411 from feedstock reel 410 and provides it to deposition head 407 with the correct tension for depositing. Accumulator 112 is described in detail by U.S. patent application Ser. No. 16/023,210, entitled “Filament Accumulator or Tensioning Assembly,” filed Jun. 29, 2018 (Attorney Docket 3019-169us1 ARVO 7916), and which is incorporated by reference.

Sensor array 415 is a thermal camera that is capable of simultaneously measuring the temperature of:
(i) feedstock region 571-1, and
(ii) feedstock region 571-2, and
(iii) feedstock region 571-3, and
(iv) workpiece region 572-1, and
(v) workpiece region 572-2, and
(vi) workpiece region 572-3, and
(vii) tamping tool 408,
   sixty (60) times per second and reporting those measurements to controller 409 via sensor cable 454. In accordance with the illustrative embodiment, sensor array 415 is a FLIR A35 thermal camera, but it will be clear to those skilled in the art, after reading this disclosure, how to make and use alternative embodiments of the present invention in which sensor array 415 comprises different hardware.

Force Gauge 413—is a mechanical strain gauge that continually measures the force of tamping tool 408 on feedstock 411 at nip line segment 581 and reports those measurements back to controller 409 via sensor cable 454. It will be clear to those skilled in the art how to make and use force gauge 413.

Feedstock laser 441 is a variable-power continuous-wave laser that generates laser beam 471 and conveys it to optical instrument 461 via optical cable 451. In accordance with the illustrative embodiment, feedstock laser 441 is directed by controller 409 to generate laser beam 471 with a specific average power over a given time-interval. In accordance with the illustrative embodiment, laser beam 471 is characterized by a wavelength λ=980 nm and has a maximum power output of 400 Watts.

In accordance with the illustrative embodiment, feedstock laser 441 is a continuous-wave laser. It will be clear to those skilled in the art, after reading this disclosure, how to make and use alternative embodiments of the present invention that use a pulsed laser. In any case, it will be clear to those skilled in the art how to make and use laser 441.

Workpiece laser 442 is a variable-power continuous-wave laser that generates laser beam 472 and conveys it to optical instrument 462 via optical cable 452. In accordance with the illustrative embodiment, workpiece laser 442 is directed by controller 409 to generate laser beam 472 with a specific average power over a given time-interval. In accordance with the illustrative embodiment, laser beam 472 is characterized by a wavelength λ=980 nm and has a maximum power output of 400 Watts.

In accordance with the illustrative embodiment, workpiece laser 442 is a continuous-wave laser. It will be clear to those skilled in the art, after reading this disclosure, how to make and use alternative embodiments of the present invention that use a pulsed laser. In any case, it will be clear to those skilled in the art how to make and use workpiece laser 442.

In accordance with the illustrative embodiment, feedstock laser 441 and workpiece laser 442 are identical and generate laser beams characterized by the same wavelength. It will be clear to those skilled in the art, however, after reading this disclosure, how to make and use alternative embodiments of the present invention in which the lasers:
(i) are not identical, or
(i) generate laser beams characterized by different wavelengths, or
(iii) have different maximum power output, or
(iv) any combination of i, ii, and iii.

Optical cable 451 is a glass fiber, in well-known fashion, that carries laser beam 471 from feedstock laser 441 to optical instrument 461 with substantially no loss. It will be clear to those skilled in the art how to make and use optical cable 451.

Optical cable 452 is a glass fiber, in well-known fashion, that carries laser beam 472 from workpiece laser 442 to optical instrument 462 with substantially no loss. It will be clear to those skilled in the art how to make and use optical cable 452.

Sensor cable 454 is an electrical cable, in well-known fashion, that carries the measurements from sensor array 415 to controller 409. It will be clear to those skilled in the art how to make and use sensor cable 454.

Optical instrument 461 is an optomechanical machine that comprises optics and actuators that receive laser beam 471 from feedstock laser 441, via optical cable 451, conditions it under the direction of controller 409, and directs it onto the segment of feedstock 411 that is within feedstock region 571-2. In particular, optical instrument 461 comprises an actuator that rotates, under the direction of controller 409, two cylindrical lenses around an axis of rotation to adjust the length of the segment of feedstock 411 that is irradiated and heated by laser beam 471 (i.e., adjusts the length of feedstock region 571-2). The design and operation of optical instrument 461 is described in detail below and in the accompanying figures.

Optical instrument 462 is an optomechanical machine that comprises optics and actuators that receive laser beam 472 from workpiece laser 442, via optical cable 452, conditions it, and directs it onto the portion of workpiece 406 that is within workpiece region 572-2, all under the direction of controller 409. In particular, optical instrument 461 comprises an actuator that rotates, under the direction of controller 409, a collimator and two cylindrical lenses around an axis of rotation to steer laser beam 472 onto deposition path 591. The design and operation of optical instrument 462 is described in detail below and in the accompanying figures.

Feedstock laser control cable 491 is an electrical cable, in well-known fashion, that carries instructions from controller 409 to feedstock laser 441, which instructions control all aspects (e.g., power, etc.) of feedstock laser 441. It will be clear to those skilled in the art how to make and use feedstock laser control cable 491.

Workpiece laser control cable 492 is an electrical cable, in well-known fashion, that carries instructions from controller 409 to workpiece laser 442, which instructions control all aspects (e.g., power, etc.) of workpiece laser 442. It will be clear to those skilled in the art how to make and use feedstock laser control cable 492.

Feedstock region 571-1, feedstock region 571-2, and feedstock region 571-3 are three volumes in space through which feedstock 411 passes.

The length of feedstock region 571-1 is defined as the length of feedstock 411 within feedstock region 571-1. In accordance with the illustrative embodiment, the length of feedstock region 571-1 is 15 mm, but it will be clear to those skilled in the art, after reading this disclosure, how to make and use alternative embodiments in which the length of feedstock region 571-1 is different.

The length of feedstock region 571-2 is defined as the length of feedstock 411 being irradiated by laser beam 471. In accordance with the illustrative embodiment, the length of feedstock region 571-2 is continually adjusted by optical instrument 461, all under the direction of controller 409. In accordance with the illustrative embodiment, the minimum length of feedstock region 571-2 is approximately 8 mm and the maximum length is approximately 40 mm, but it will be clear to those skilled in the art, after reading this disclosure, how to make and use alternative embodiments of the present invention in which the minimum and maximum lengths are different.

The length of feedstock region 571-3 is defined as the length of feedstock 411 within feedstock region 571-3. In accordance with the illustrative embodiment, the length of feedstock region 571-3 is 10 mm, but it will be clear to those skilled in the art, after reading this disclosure, how to make and use alternative embodiments in which the length of the feedstock region 571-3 is different.

In accordance with the illustrative embodiment, the distance of feedstock region 571-1 from pinch line segment 582 (as measured along the length of feedstock 411) is 55 mm, but it will be clear to those skilled in the art, after reading this disclosure, how to make and use alternative embodiments in which the distance is different.

In accordance with the illustrative embodiment, the distance of feedstock region 571-2 from pinch line segment 582 (as measured along the length of feedstock 411) is continually adjusted by optical instrument 461, all under the direction of controller 409. In accordance with the illustrative embodiment, the minimum distance of feedstock region 571-2 from pinch line segment 582 is 24 mm and the maximum distance is 40 mm, but it will be clear to those skilled in the art, after reading this disclosure, how to make and use alternative embodiments of the present invention in which the minimum and maximum lengths are different.

In accordance with the illustrative embodiment, the distance of feedstock region 571-3 from pinch line segment 582 (as measured along the length of feedstock 411) is 5 mm but it will be clear to those skilled in the art, after reading this disclosure, how to make and use alternative embodiments in which the distance is different.

Workpiece region 572-1, workpiece region 572-2, and workpiece region 572-3 are three volumes in space through which deposition path 591 passes.

The length of workpiece region 572-1 is defined as the length of deposition path 591 within workpiece region 572-1. In accordance with the illustrative embodiment, the length of workpiece region 572-1 is 15 mm, but it will be clear to those skilled in the art, after reading this disclosure, how to make and use alternative embodiments in which the length of workpiece region 572-1 is different.

The length of workpiece region 572-2 is defined as the length of deposition path 591 being irradiated by laser beam 471. In accordance with the illustrative embodiment, the length of feedstock region 571-2 is approximately 20 mm, but it will be clear to those skilled in the art, after reading this disclosure, how to make and use alternative embodiments of the present invention in which the minimum and maximum lengths are different.

The length of workpiece region 572-3 is defined as the length of deposition path 591 within workpiece region 572-3. In accordance with the illustrative embodiment, the length of workpiece region 572-3 is 10 mm, but it will be clear to those skilled in the art, after reading this disclosure, how to make and use alternative embodiments in which the length of the workpiece region 572-3 is different.

In accordance with the illustrative embodiment, the distance of workpiece region 572-1 from pinch line segment 582 (as measured along the length of deposition path 591) is 55 mm, but it will be clear to those skilled in the art, after reading this disclosure, how to make and use alternative embodiments in which the distance is different.

In accordance with the illustrative embodiment, the distance of workpiece region 572-2 from pinch line segment 582 (as measured along the length of deposition path 591) is approximately 25 mm, but it will be clear to those skilled in the art, after reading this disclosure, how to make and use alternative embodiments of the present invention in which the minimum and maximum lengths are different.

Nip line segment 581 is line segment on the circumferential surface of tamping tool 408 where tamping tool 408 exerts the maximum radial force on feedstock 411.

Pinch line segment 582 is the line segment on the circumferential surface of tamping tool 408 where tamping tool 408 first pinches a unit-length of feedstock 411 between tamping tool 408 and workpiece 406 so that any movement of feedstock 411 parallel to the rotational axis of tamping tool 408 is substantially constrained.

Deposition path 591 is a line on the surface of workpiece 406 where feedstock 411 is to be deposited and tamped. In FIG. 5b, deposition path 591 curves to the left. In contrast, in FIG. 6, deposition path 591 curves to the right.

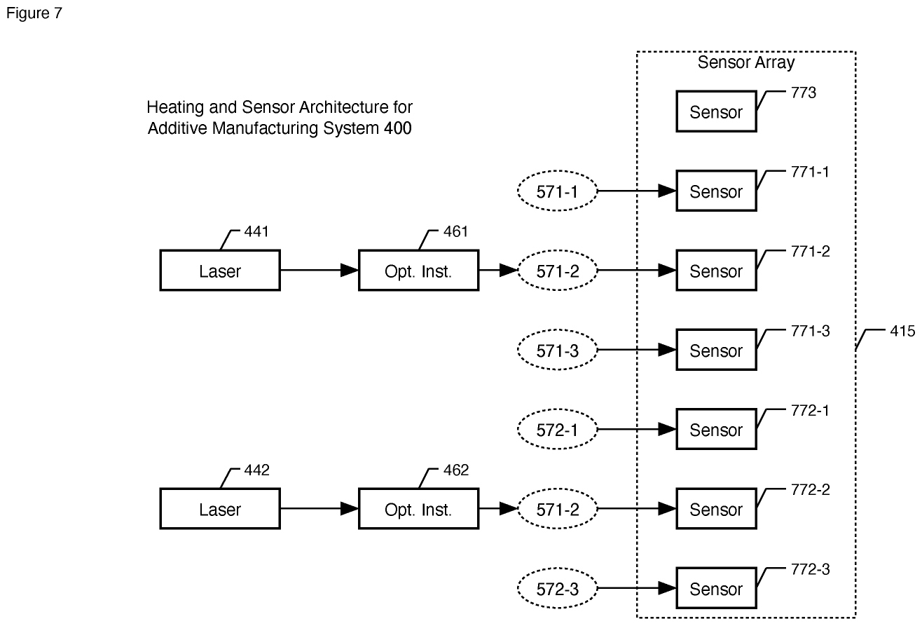

FIG. 7 depicts a schematic diagram of the heating and sensor architecture for additive manufacturing system 400, which irradiates and heats feedstock 411 and workpiece 406 and measures the temperature of feedstock 411, workpiece 406, and tamping tool 408.

As shown in FIG. 7, feedstock laser 441 provides laser beam 471 to optical instrument 461 via optical cable 451 in well-known fashion, and workpiece laser 442 provides laser beam 472 to optical instrument 462 via optical cable 452.

Under the direction of controller 409, optical instrument 461 irradiates and heats the segment of feedstock that is within feedstock region 571-2, and optical instrument 462 irradiates and heats the portion of workpiece 406 that is within workpiece region 572-2.

Thermal sensor 771-1 periodically measures the temperature of the segment of feedstock that is within feedstock region 571-1 and reports those measurements back to controller 409. Thermal sensor 771-2 periodically measures the temperature of the segment of feedstock that is within feedstock region 571-2 and reports those measurements back to controller 409. Thermal sensor 771-3 periodically measures the temperature of the segment of feedstock that is within feedstock region 571-3 and reports those measurements back to controller 409.

Thermal sensor 772-1 periodically measures the temperature of that portion of workpiece 406 that is within workpiece region 572-1 and reports those measurements back to controller 409. Thermal sensor 772-2 periodically measures the temperature of that portion of workpiece 406 that is within workpiece region 572-2 and reports those measurements back to controller 409. Thermal sensor 772-3 periodically measures the temperature of that portion of workpiece 406 that is within workpiece region 572-3 and reports those measurements back to controller 409.

Thermal sensor 773 periodically measures the temperature of tamping tool 408 and reports those measurements back to controller 409.

Although the illustrative embodiment measures the temperature of three segments of feedstock 411, it will be clear to those skilled in the art, after reading this disclosure, how to make and use alternative embodiments of the present invention that measure any number (e.g., four, five, six, eight, ten, twelve, etc.) of segments. Although the illustrative embodiment measures the temperature of three portions of workpiece 406, it will be clear to those skilled in the art, after reading this disclosure, how to make and use alternative embodiments of the present invention that measure any number (e.g., four, five, six, eight, ten, twelve, etc.) of portions.

In accordance with the illustrative embodiment, the temperature measurements are made periodically at sixty (60) times per second, but it will be clear to those skilled in the art, after reading this disclosure, how to make and use alternative embodiments of the present invention that make periodic measurements at a different rate or that make measurements aperiodically or sporadically.

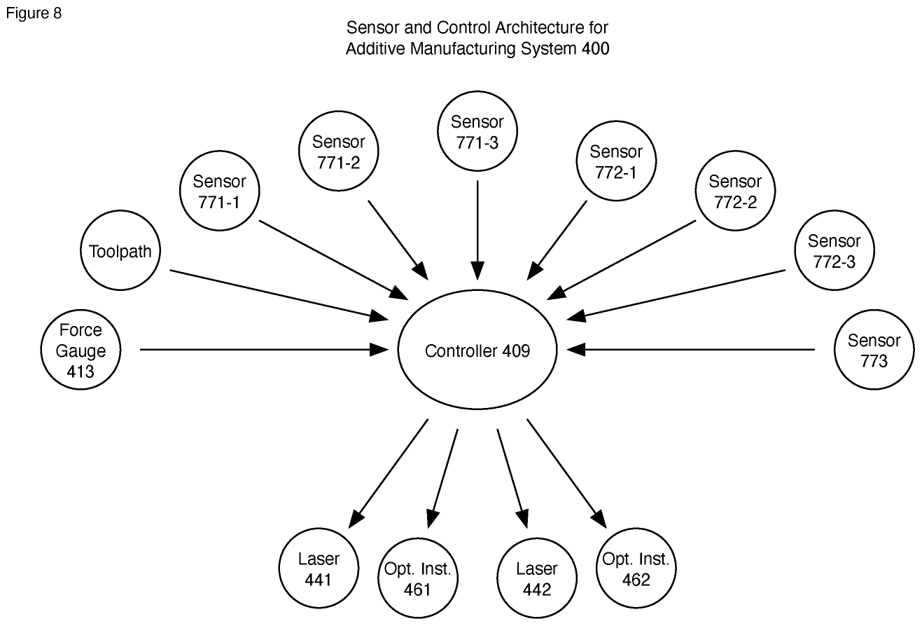

FIG. 8 depicts a schematic diagram of the sensor and control architecture for that portion of additive manufacturing system 400 that irradiates and heats feedstock 411 and workpiece 406.

In accordance with the illustrative embodiment, controller 409 uses a combination of feedforward and feedback to continually direct:
(i) feedstock laser 441 to adjust the average power of laser beam 471 on the segment of feedstock that is within feedstock region 571-2, and
(ii) optical instrument 461 to adjust the angle of rotation θ of laser beam 471 so as to adjust the length of feedstock 411 irradiated by laser beam 471, and
(iii) workpiece laser 442 to adjust the average power of laser beam 472 on the portion of workpiece that is within workpiece region 572-2, and
(iv) optical instrument 462 to adjust the angle of rotation θ of laser beam 472 so as to steer laser beam 472 onto deposition path 591, and
(v) accumulator 412 to feed feedstock 411 to deposition head 407, and
(vi) robot 403 to advance tamping tool 408 to deposit and tamp feedstock 411 onto workpiece 406,
   based on:
(i) knowledge of the toolpath (e.g., G-code, etc.) for the article of manufacture to be printed (and the geometry of the workpiece at each time-interval, which can be derived from that toolpath), and
(ii) a thermal model of the feedstock 411, and
(iii) a location-specific thermal model of each portion on workpiece 406 onto which feedstock 411 will be deposited and tamped (which can be derived from the thermal model of the feedstock 411 and the geometry of the workpiece at each instant during fabrication), and
(iv) periodic measurements of the temperature of the segment of feedstock 411 that is within feedstock region 571-1, and
(v) periodic measurements of the temperature of the segment of feedstock 411 that is within feedstock region 571-2, and
(vi) periodic measurements of the temperature of the segment of feedstock 411 that is within feedstock region 571-3, and
(vii) periodic measurements of the temperature of that portion of workpiece that is within workpiece region 572-1, and
(viii) periodic measurements of the temperature of that portion of workpiece that is within workpiece region 572-2, and
(ix) periodic measurements of the temperature of that portion of workpiece that is within workpiece region 572-3, and
(x) periodic measurements of the temperature of tamping tool 408, and
(xi) periodic measurements of the force of tamping tool 408 on feedstock 411 at nip line segment 581.

It will be clear to those skilled in the art, after reading this disclosure, how to make and use embodiments of the present invention that accomplish this, whether with traditional imperative programming or with an artificial neural network.

With regard to feedforward, controller 409 takes as input:
(i) the toolpath (e.g., G-code, etc.) for the article of manufacture to be printed, in well-known fashion, and
(ii) a thermal model of the feedstock, which itself is based on, among other things, the thermal properties of the resin, the mass of resin per unit-length of feedstock, the profile of the feedstock (e.g., filament, tape, circular, rectangular, etc.), the thermal properties of the reinforcing fibers, the number of fibers per unit-length of feedstock, the mass of the fibers per unit-length of feedstock, and the length and orientation of the fibers in the feedstock (e.g., continuous, chopped, medium, ball milled, etc.),
   and generates therefrom:
(i) a prediction of whether feedstock 411 will be deposited at a uniform or non-uniform rate at each instant during the printing of the article of manufacture (because, for example and without limitation, the deposition starts and stops, accelerates, decelerates and occurs uniformly because of turns, contours, cuts, etc.), and
(ii) a prediction of the speed (e.g., in millimeters per second, etc.) at which feedstock 411 will be deposited at each instant during the printing of the article of manufacture, and
(iii) a prediction of the interval of time between when each segment of feedstock 411 is irradiated and heated and when the segment is deposited and tamped, and
(iv) a prediction of the interval of time between when each portion of workpiece 406 is irradiated and heated and when feedstock 411 is deposited and tamped onto that portion of workpiece 406, and
(v) a location-specific thermal model of each portion on workpiece 406 onto which feedstock 411 will be deposited and tamped, which itself is based on, among other things, the thermal model of the feedstock and the shape and mass of the workpiece in the vicinity of each portion to be irradiated and heated, which is derived from a model of the nascent article of manufacture (i.e., workpiece) at each step of printing, which is derived from the toolpath, and
(vi) a prediction of the angle of rotation θ for laser beam 471 during each time-interval, and
(vii) a prediction of the angle of rotation θ for laser beam 472 during each time-interval.

With regard to feedback, controller 409 takes as input:
(i) the thermal model of the feedstock, and
(ii) the location-specific thermal model of each portion on workpiece 406 onto which feedstock 411 will be deposited and tamped, and
(iii) periodic measurements of the temperature of the segment of feedstock 411 that is within feedstock region 571-1, and
(iv) periodic measurements of the temperature of the segment of feedstock 411 that is within feedstock region 571-2, and
(v) periodic measurements of the temperature of the segment of feedstock 411 that is within feedstock region 571-3, and
(vi) periodic measurements of the temperature of that portion of workpiece that is within workpiece region 572-1, and
(vii) periodic measurements of the temperature of that portion of workpiece that is within workpiece region 572-2, and
(viii) periodic measurements of the temperature of that portion of workpiece that is within workpiece region 572-3, and
(ix) the periodic measurements of the temperature of tamping tool 408, and
(x) periodic measurements of the force of tamping tool 408 on feedstock 411 at nip line segment 581.

It will be clear to those skilled in the art, after reading this disclosure, how to make and use a thermal model of the feedstock, a location-specific thermal model of each portion on workpiece 406 onto which feedstock 411 will be deposited and tamped, a prediction of whether the feedstock will be deposited at a uniform or non-uniform rate, a prediction of the speed at which the feedstock is deposited, and a prediction of the interval between when each segment of feedstock and each portion of the workpiece is irradiated and heated and when the segment is deposited and tamped onto the portion of the workpiece.

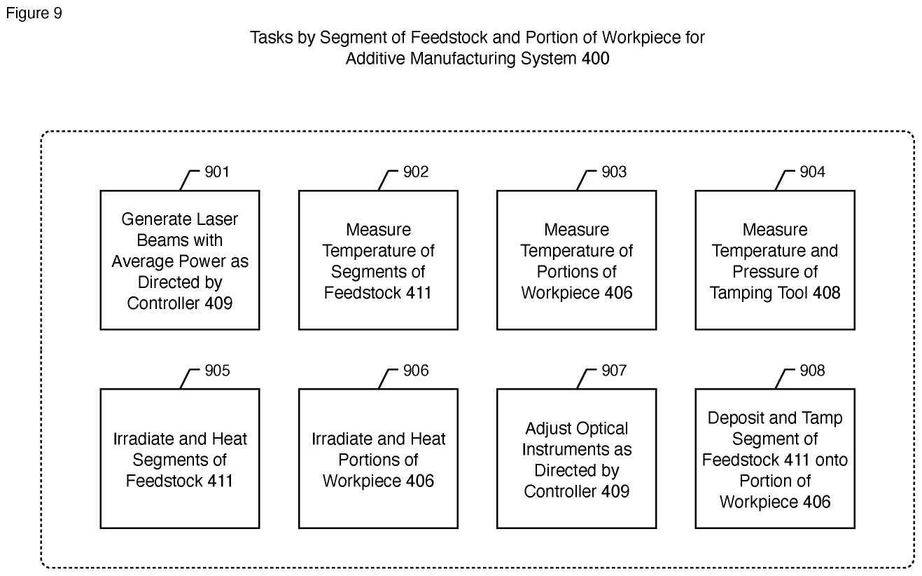

FIG. 9 depicts a flowchart of the tasks performed by additive manufacturing system 400. Because additive manufacturing system 400 concurrently performs tasks on different segments of feedstock 411 and different portions of workpiece 406, the tasks depicted in FIG. 9 are concurrent.

At task 901:
(i) feedstock laser 441 generates laser beam 471 with an average power during each time-interval, and
(ii) workpiece laser 442 generates laser beam 472 with an average power during each time-interval, and
   both as directed by controller 409. It will be clear to those skilled in the art, after reading this disclosure, how to make and use embodiments of the present invention that perform task 901.

At task 902, thermal sensor 771-1 periodically measures the temperature of the segment of feedstock 411 that is within feedstock region 571-1 and reports those measurements to controller 409. Additionally, thermal sensor 771-2 periodically measures the temperature of the segment of feedstock 411 that is within feedstock region 571-2 and reports those measurements to controller 409. And furthermore, thermal sensor 771-3 periodically measures the temperature of the segment of feedstock 411 that is within feedstock region 571-3 and reports those measurements to controller 409. It will be clear to those skilled in the art, after reading this disclosure, how to make and use embodiments of the present invention that perform task 901.

At task 903, thermal sensor 772-1 periodically measures the temperature of that portion of workpiece 406 that is within workpiece region 572-1 and reports those measurements to controller 409. Additionally, thermal sensor 772-2 periodically measures the temperature of that portion of workpiece 406 that is within workpiece region 572-2 and reports those measurements to controller 409. And furthermore, thermal sensor 772-3 periodically measures the temperature of that portion of workpiece 406 that is within workpiece region 572-3 and reports those measurements to controller 409. It will be clear to those skilled in the art, after reading this disclosure, how to make and use embodiments of the present invention that perform task 901.

At task 904, thermal sensor 773 periodically measures the temperature of tamping tool 408 and reports those measurements back to controller 409. Additionally, force gauge 413 periodically measures the force of tamping tool 408 on feedstock 411 at nip line segment 581 and reports those measurements back to controller 409.

At task 905, optical instrument 461 irradiates and heats the segment of feedstock 411 that is within feedstock region 571-2 as directed by controller 409. The operation of optical instrument 461 in the performance of task 905 is described in detail below and in the accompanying figures.

At task 906, optical instrument 462 irradiates and heats the portion of workpiece 406 that is within workpiece region 572-2 as directed by controller 409. The operation of optical instrument 462 in the performance of task 906 is described in detail below and in the accompanying figures.

At task 907:
(i) optical instrument 461 adjusts a trait of laser beam 471 and/or the relationship of laser beam 471 to the segment of feedstock 411 within feedstock region 571-2, and
(ii) optical instrument 462 adjusts a trait of laser beam 472 and/or the relationship of laser beam 472 to the portion of workpiece 406 within workpiece region 572-2, and both as directed by controller 409. Task 907 is described in detail below and in the accompanying figures.

At task 908, additive manufacturing system 400 deposits a segment of feedstock 411 onto a portion of workpiece 406 and tamps the segment onto the workpiece with tamping tool 408. It will be clear to those skilled in the art, after reading this disclosure, how to make and use embodiments of the present invention that perform task 908.

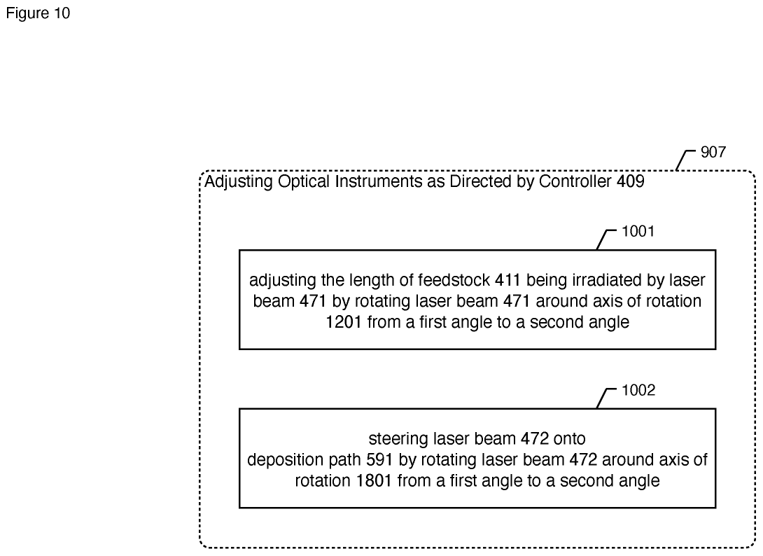

FIG. 10 depicts a flowchart of the details of task 907—adjusting optical instrument 461 and optical instrument 462, as directed by controller 409. Controller 409 continually directs optical instrument 461 and optical instrument 462 to make adjustments, and, therefore, the tasks depicted in FIG. 10 are concurrent.

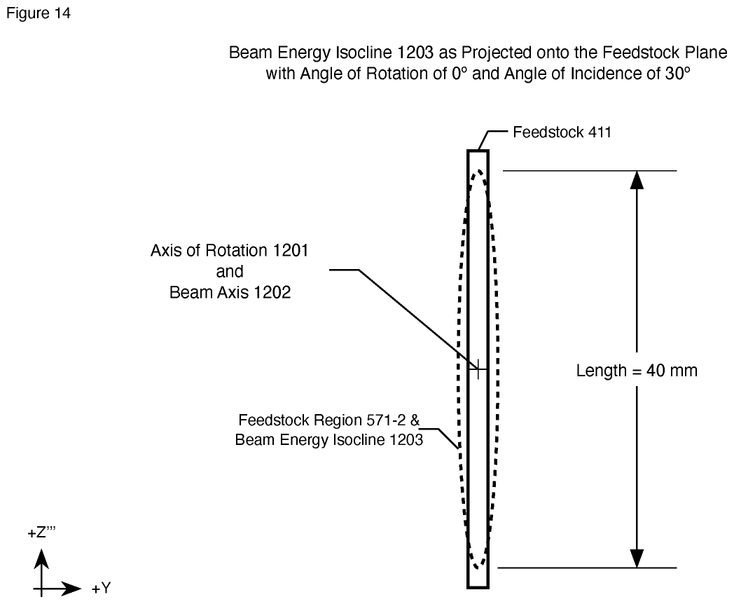

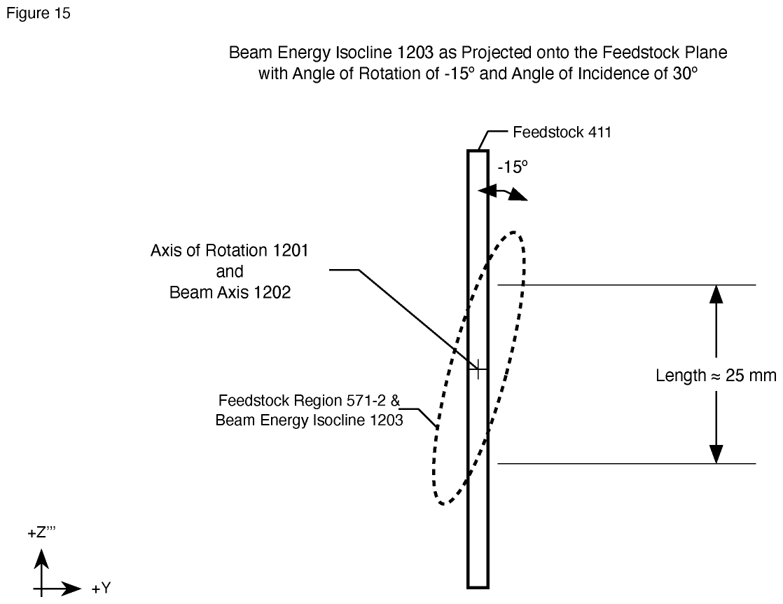

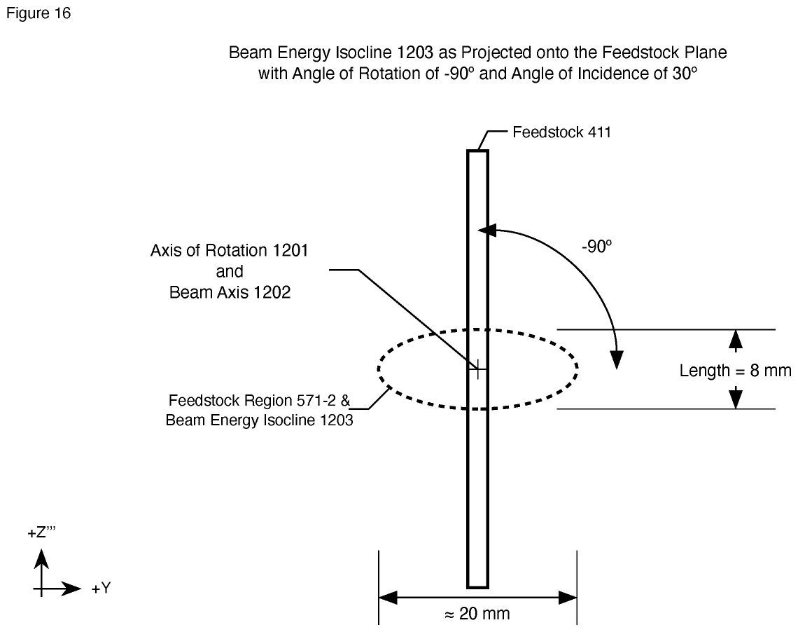

At task 1001, controller 409 directs optical instrument 461 to adjust the length of feedstock region 571-2 (i.e., the length of feedstock 411 being irradiated by laser beam 471) by rotating laser beam 471 around axis of rotation 1201 (as depicted in FIGS. 14, 15, and 16) from a first angle of rotation θ₁ to a second angle of rotation θ₂. For example and without limitation, laser beam 471 is depicted at angle of rotation θ=0° in FIG. 14, at angle of rotation θ=−15° in FIG. 15, and at angle of rotation θ=−90° in FIG. 16. At angle of rotation θ=0°, the length of feedstock region 571-2 is approximately 40 mm; at angle of rotation θ=−15°, the length of feedstock region 571-2 is approximately 25 mm, and at angle of rotation θ=−90°, the length of feedstock region 571-2 is approximately 8 mm. It will be clear to those skilled in the art, after reading this disclosure, that the length of feedstock 571-2 is adjustable between approximately 40 mm and approximately 8 mm by adjusting the angle of rotation θ between 0° and −90°.

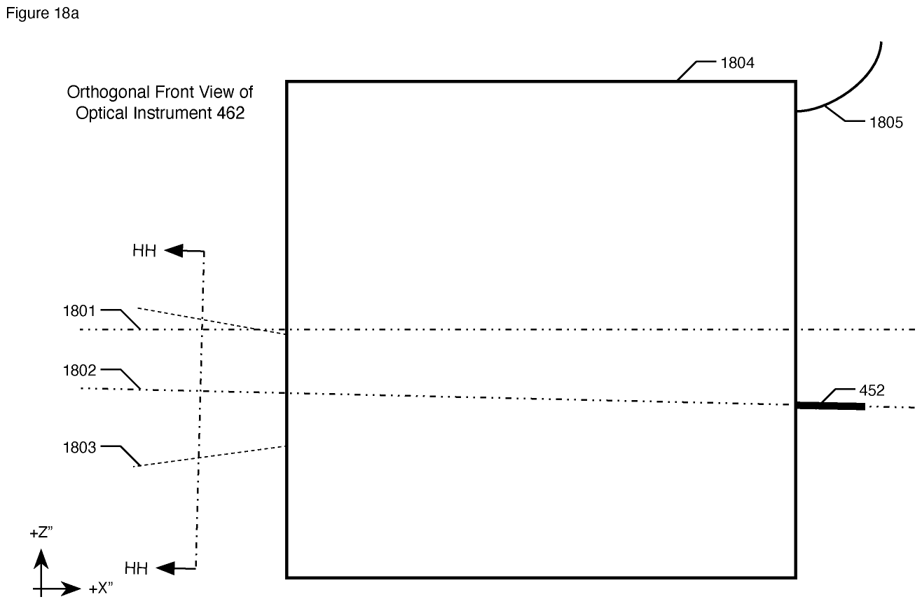

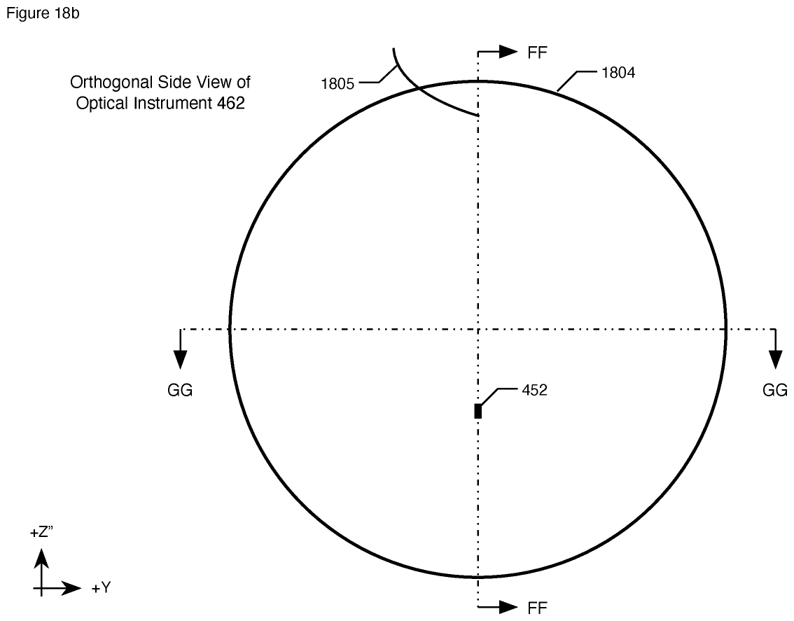

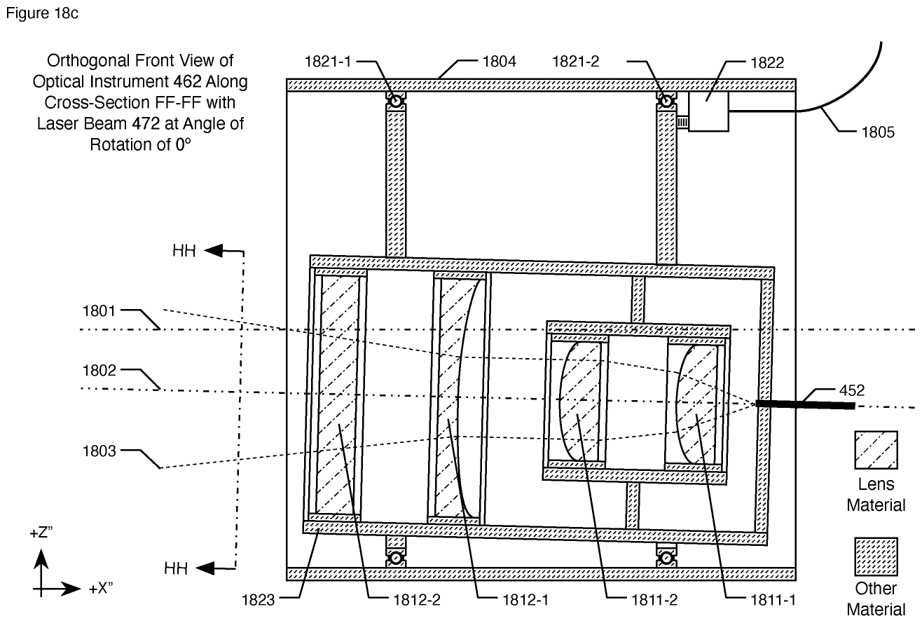

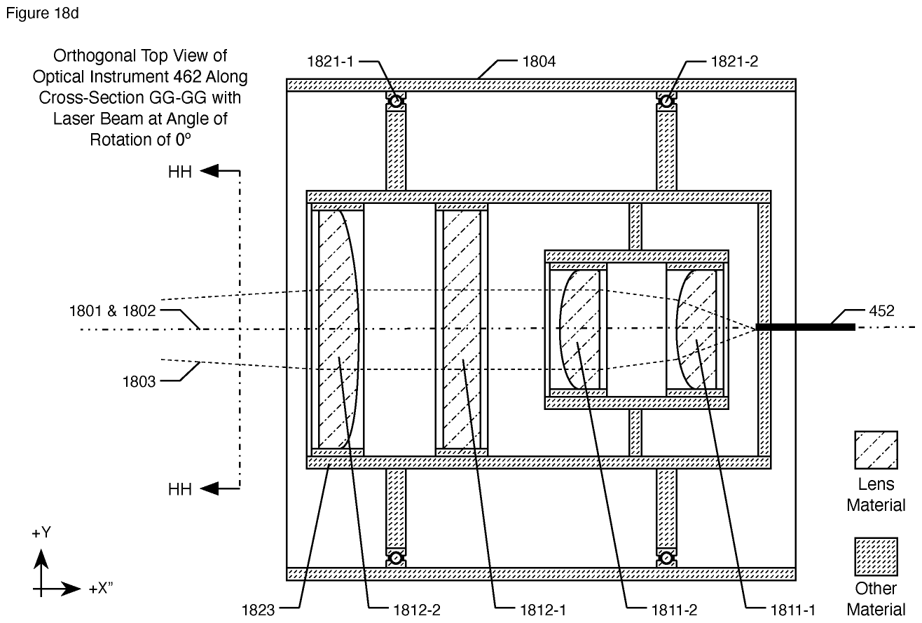

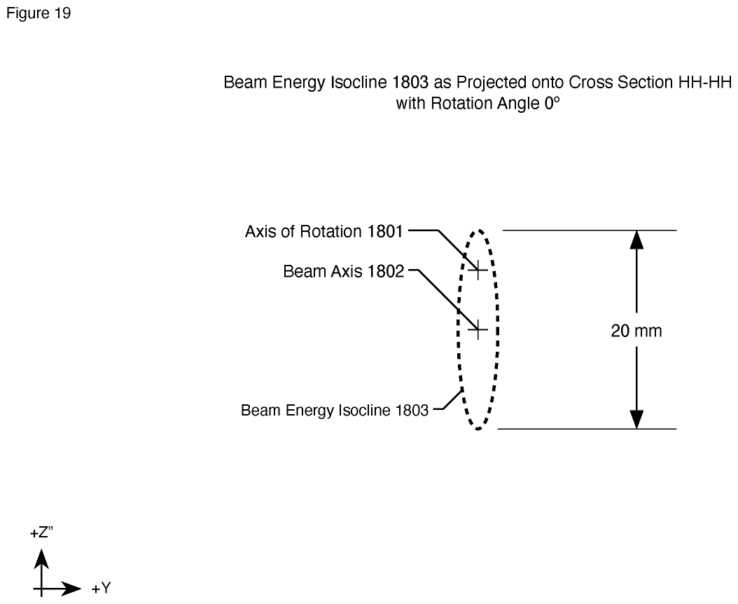

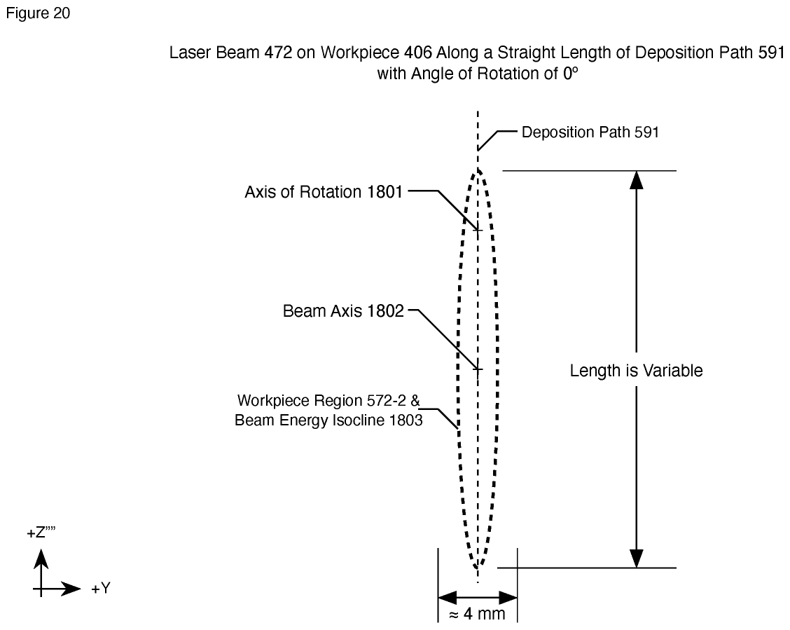

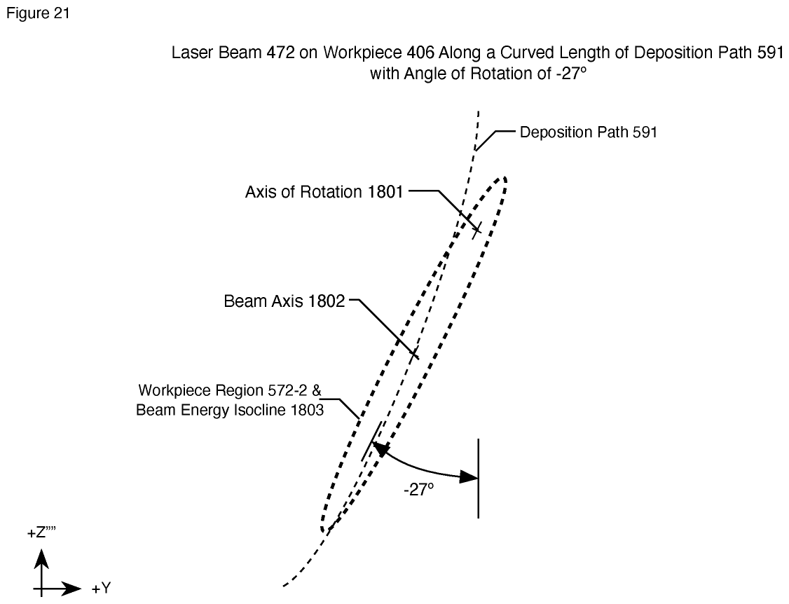

At task 1002, controller 409 directs optical instrument 462 to steer workpiece laser beam 472 onto deposition path 591 by rotating the beam axis of laser beam 472 around axis of rotation 1801 (depicted in FIGS. 18a, 18c, and 18d). For example and without limitation, laser beam 471 is depicted at angle 0° in FIG. 19, at angle −27° in FIG. 20, and at angle +27° in FIG. 21. In each case, laser beam 472 is rotated around axis of rotation 1801 so as to place beam axis 1802 onto deposition path 591. It will be clear to those skilled in the art, after reading this disclosure, that the angle of laser beam 472 is continually adjustable between −90° and +90°.

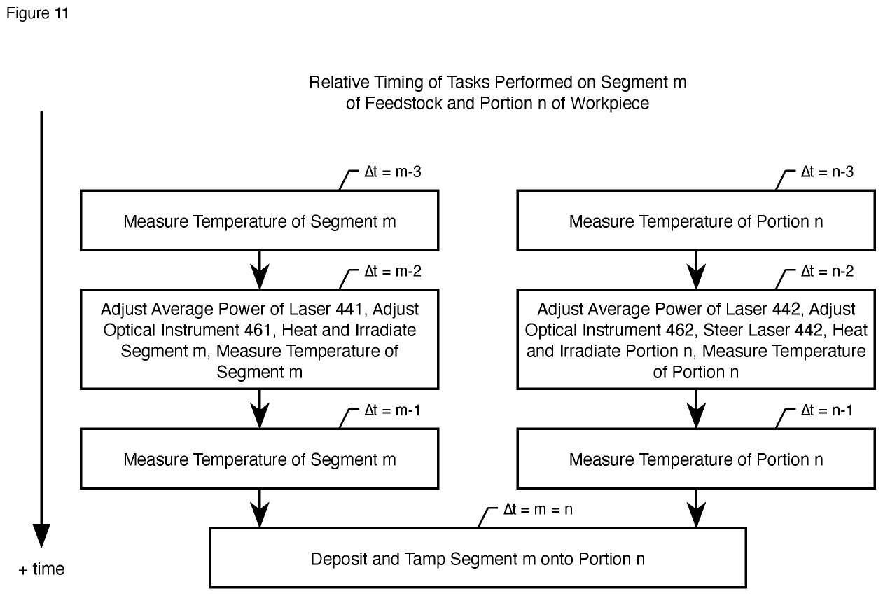

FIG. 11 depicts a flowchart of the relative timing of the tasks performed on segment m of feedstock 411 and on portion n of workpiece 406, wherein m and n are integers. In accordance with the illustrative embodiment segment m of feedstock 411 is deposited and tamped onto portion n of workpiece 406.

During time-interval Δt=m−3, the temperature of segment m of feedstock 411 is measured by thermal sensor 771-1 and reported to controller 409.

During time-interval Δt=n−3, the temperature of portion n of workpiece 406 is measured by thermal sensor 772-1 and reported to controller 409.

In accordance with the illustrative embodiment, the duration of time-interval Δt=m−3 equals the duration of time-interval Δt=n−3, and time-interval Δt=m−3 is contemporaneous with time-interval Δt=n−3. It will be clear to those skilled in the art, however, after reading this disclosure, how to make and use alternative embodiments of the present invention in which the duration of time-interval Δt=m−3 does not equal the duration of time-interval Δt=n−3. Furthermore, it will be clear to those skilled in the art, after reading this disclosure, how to make and use alternative embodiments of the present invention in which time-interval Δt=m−3 is not contemporaneous with time-interval Δt=n−3. And still furthermore, it will be clear to those skilled in the art, after reading this disclosure, how to make and use alternative embodiments of the present invention in which time-interval Δt=m−3 overlaps, immediately precedes, immediately succeeds, precedes but not immediately, or succeeds but not immediately time-interval Δt=n−3.

During time-interval Δt=m−2:
(i) controller 409 directs feedstock laser 441 to generate laser beam 471 with a given average power, and
(ii) controller 409 directs optical instrument 461 to rotate laser beam 471 around an axis of rotation, and
(iii) optical instrument 461 irradiates and heats segment m of feedstock 411, and
(iv) the temperature of segment m of feedstock 411 is measured by thermal sensor 771-2 and reported to controller 409.
   In accordance with the illustrative embodiment, the duration of time-interval Δt=m−2 equals the duration of Δt=m−3. It will be clear to those skilled in the art, however, after reading this disclosure, how to make and use alternative embodiments of the present invention in which the duration of time-interval Δt=m−2 does not equal the duration of time-interval Δt=m−3.

Furthermore, in accordance with the illustrative embodiment, time-interval Δt=m−2 is after, and is mutually-exclusive of, time-interval Δt=m−3. It will be clear to those skilled in the art, however, after reading this disclosure, how to make and use alternative embodiments of the present invention in which time-interval Δt=m−2 overlaps, immediately succeeds, or succeeds but not immediately, time-interval Δt=m−3.

During time-interval Δt=n−2:
(i) controller 409 directs workpiece laser 442 to generate laser beam 472 with a given average power, and
(iii) controller 409 directs optical instrument 462 to steer laser beam 472 onto deposition path 591 by rotating laser beam 472 around an axis of rotation, and
(iv) optical instrument 462 irradiates and heats portion n of workpiece 406, and
(v) the temperature of portion n of workpiece 406 is measured by thermal sensor 772-2 and reported to controller 409.

In accordance with the illustrative embodiment, the duration of time-interval Δt=n−2 equals the duration of Δt=n−3. It will be clear to those skilled in the art, however, after reading this disclosure, how to make and use alternative embodiments of the present invention in which the duration of time-interval Δt=n−2 does not equal the duration of time-interval Δt=n−3. Furthermore, in accordance with the illustrative embodiment, time-interval Δt=n−2 is after, and is mutually-exclusive of, time-interval Δt=n−3. It will be clear to those skilled in the art, however, after reading this disclosure, how to make and use alternative embodiments of the present invention in which time-interval Δt=n−2 overlaps, immediately succeeds, or succeeds but not immediately, time-interval Δt=n−3.

In accordance with the illustrative embodiment, the duration of time-interval Δt=m−2 equals the duration of time-interval Δt=n−2, and time-interval Δt=m−2 is contemporaneous with time-interval Δt=n−2. It will be clear to those skilled in the art, however, after reading this disclosure, how to make and use alternative embodiments of the present invention in which the duration of time-interval Δt=m−2 does not equal the duration of time-interval Δt=n−2. Furthermore, it will be clear to those skilled in the art, after reading this disclosure, how to make and use alternative embodiments of the present invention in which time-interval Δt=m−2 is not contemporaneous with time-interval Δt=n−2. And still furthermore, it will be clear to those skilled in the art, after reading this disclosure, how to make and use alternative embodiments of the present invention in which time-interval Δt=m−2 overlaps, immediately precedes, immediately succeeds, precedes but not immediately, or succeeds but not immediately time-interval Δt=n−2.

During time-interval Δt=m−1, the temperature of segment m of feedstock 411 is measured by thermal sensor 771-3 and reported to controller 409.

In accordance with the illustrative embodiment, the duration of time-interval Δt=m−1 equals the duration of Δt=m−2. It will be clear to those skilled in the art, however, after reading this disclosure, how to make and use alternative embodiments of the present invention in which the duration of time-interval Δt=m−1 does not equal the duration of time-interval Δt=m−2. Furthermore, in accordance with the illustrative embodiment, time-interval Δt=m−1 is after, and is mutually-exclusive of, time-interval Δt=m−2. It will be clear to those skilled in the art, however, after reading this disclosure, how to make and use alternative embodiments of the present invention in which time-interval Δt=m−1 overlaps, immediately succeeds, or succeeds but not immediately, time-interval Δt=m−2.

During time-interval Δt=n−1, the temperature of portion n of workpiece 406 is measured by thermal sensor 772-3 and reported to controller 409.

In accordance with the illustrative embodiment, the duration of time-interval Δt=n−1 equals the duration of Δt=n−2. It will be clear to those skilled in the art, however, after reading this disclosure, how to make and use alternative embodiments of the present invention in which the duration of time-interval Δt=n−1 does not equal the duration of time-interval Δt=n−2. Furthermore, in accordance with the illustrative embodiment, time-interval Δt=n−1 is after, and is mutually-exclusive of, time-interval Δt=n−2. It will be clear to those skilled in the art, however, after reading this disclosure, how to make and use alternative embodiments of the present invention in which time-interval Δt=n−1 overlaps, immediately succeeds, or succeeds but not immediately, time-interval Δt=n−2.

In accordance with the illustrative embodiment, the duration of time-interval Δt=m−1 equals the duration of time-interval Δt=n−1, and time-interval Δt=m−1 is contemporaneous with time-interval Δt=n−1. It will be clear to those skilled in the art, however, after reading this disclosure, how to make and use alternative embodiments of the present invention in which the duration of time-interval Δt=m−1 does not equal the duration of time-interval Δt=n−1. Furthermore, it will be clear to those skilled in the art, after reading this disclosure, how to make and use alternative embodiments of the present invention in which time-interval Δt=m−1 is not contemporaneous with time-interval Δt=n−1. And still furthermore, it will be clear to those skilled in the art, after reading this disclosure, how to make and use alternative embodiments of the present invention in which time-interval Δt=m−1 overlaps, immediately precedes, immediately succeeds, precedes but not immediately, or succeeds but not immediately time-interval Δt=n−1.

During time-interval Δt=m=n, segment m of feedstock 411 is deposited and tamped onto portion n of workpiece 406.

In accordance with the illustrative embodiment, the duration of time-interval Δt=m equals the duration of Δt=m−1. It will be clear to those skilled in the art, however, after reading this disclosure, how to make and use alternative embodiments of the present invention in which the duration of time-interval Δt=m does not equal the duration of time-interval Δt=m−1. Furthermore, in accordance with the illustrative embodiment, time-interval Δt=m is after, and is mutually-exclusive of, time-interval Δt=m−1. It will be clear to those skilled in the art, however, after reading this disclosure, how to make and use alternative embodiments of the present invention in which time-interval Δt=m overlaps, immediately succeeds, or succeeds but not immediately, time-interval Δt=m−1.

In accordance with the illustrative embodiment, the duration of time-interval Δt=n equals the duration of Δt=n−1. It will be clear to those skilled in the art, however, after reading this disclosure, how to make and use alternative embodiments of the present invention in which the duration of time-interval Δt=n does not equal the duration of time-interval Δt=n−1. Furthermore, in accordance with the illustrative embodiment, time-interval Δt=n is after, and is mutually-exclusive of, time-interval Δt=n−1. It will be clear to those skilled in the art, however, after reading this disclosure, how to make and use alternative embodiments of the present invention in which time-interval Δt=n overlaps, immediately succeeds, or succeeds but not immediately, time-interval Δt=n−1.

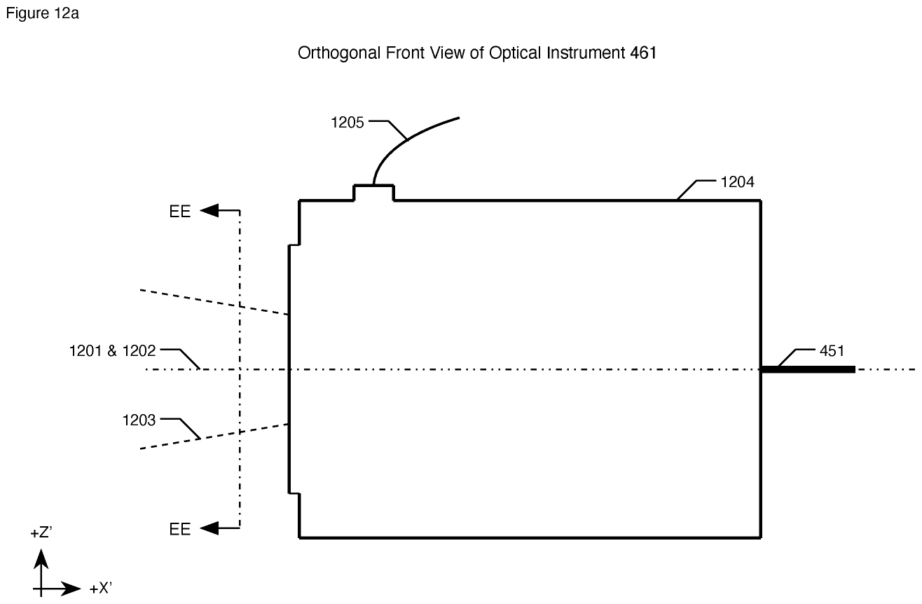

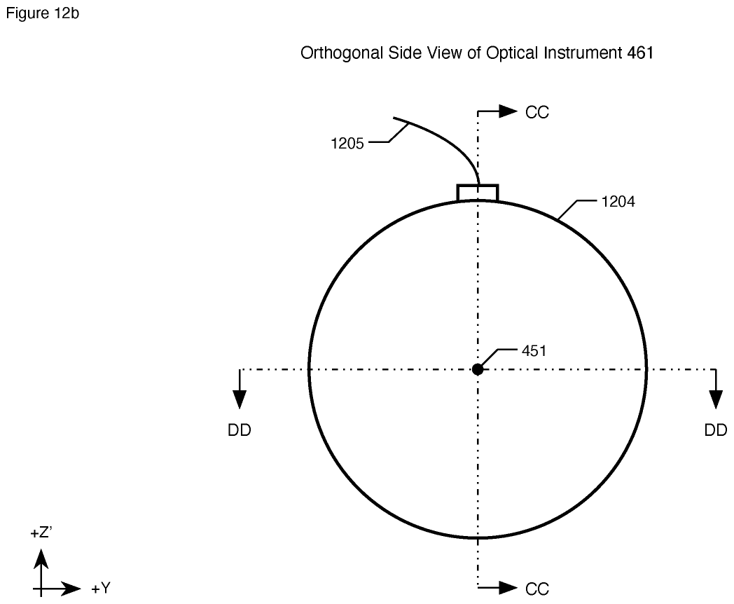

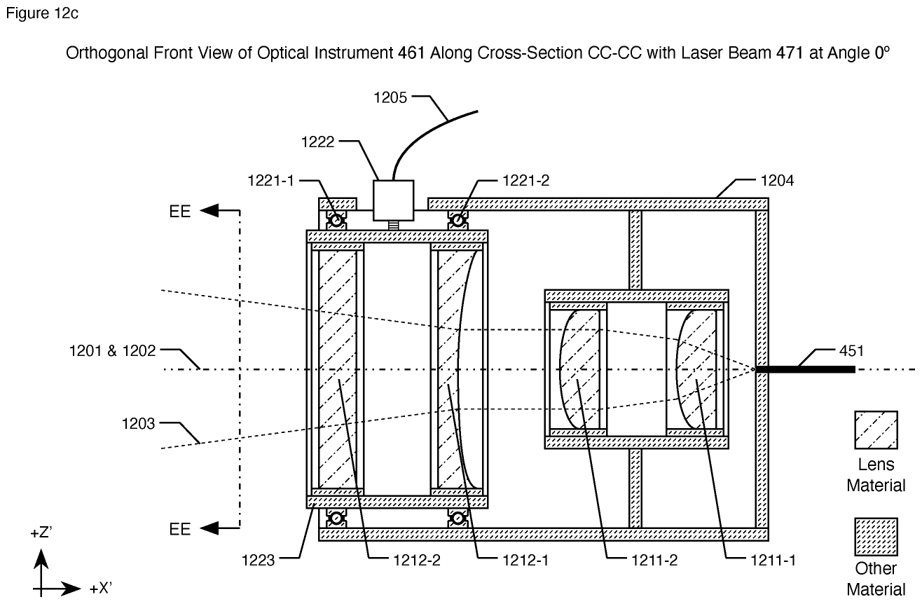

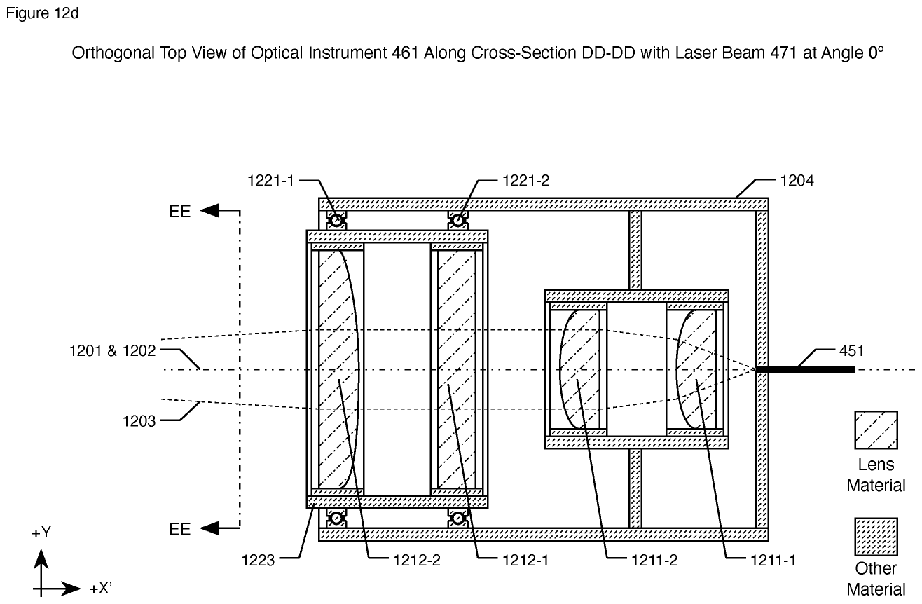

FIG. 12a depicts a front orthographic representation of optical instrument 461 in accordance with the illustrative embodiment of the present invention. FIG. 12b depicts a side orthographic representation of optical instrument 461. FIG. 12c depicts a front orthographic representation of optical instrument 461 along cross-section CC-CC. FIG. 12d depicts a top orthographic representation of optical instrument along cross-section DD-DD.

FIGS. 12a, 12b, 12c, and 12d are figurative and not drawn to scale; they do not depict hidden features, and FIGS. 12a, 12b, 12c, 12d, 13, and 17 are described with respect to a right-handed coordinate system X′—Y—Z′ that is specific to optical instrument 461. It will be clear to those skilled in the art, after reading this disclosure, how to rotate the coordinate system of optical instrument 461 around the Y axis to place it in the X—Y—Z coordinate system of additive manufacturing system 400, as shown in FIGS. 4, 5a, and 5b.

Optical instrument 461 comprises: axis of rotation 1201, beam axis 1202, beam energy isocline 1203, instrument housing 1204, control cable 1205, collimating lens 1211-1, collimating lens 1211-2, cylindrical lens 1212-1, cylindrical lens 1212-2, rotary bearing 1221-1, rotary bearing 1221-2, position-controlled actuator 1222, and bearing shroud 1223.

Axis of rotation 1201 is a line in space around which cylindrical lens 1212-1, cylindrical lens 1212-2, bearing shroud 1223, and laser beam 471 rotate, under the direction of controller 409. In accordance with the illustrative embodiment, axis of rotation 120 intersects feedstock 411 in the center of feedstock region 571-2. It will be clear to those skilled in the art, after reading this disclosure, how to make and use alternative embodiments of the present invention in which the axis of rotation does not intersect the feedstock. Furthermore, it will be clear to those skilled in the art, after reading this disclosure, how to make and use alternative embodiments of the present invention in which the axis of rotation does not intersect the center of the feedstock region (i.e., the axis of rotation is not collinear with the beam axis).

Beam axis 1202 is a line in space that is the energy-weighted centroid of the area enclosed by beam energy isocline 1203. In accordance with the illustrative embodiment, beam axis 1202 is collinear with axis of rotation 1201. It will be clear to those skilled in the art, after reading this disclosure, how to make alternative embodiments of the present invention in which the beam axis:
(i) is parallel with the axis of rotation, or
(ii) intersects the axis of rotation, or
(iii) is skew with the axis of rotation.

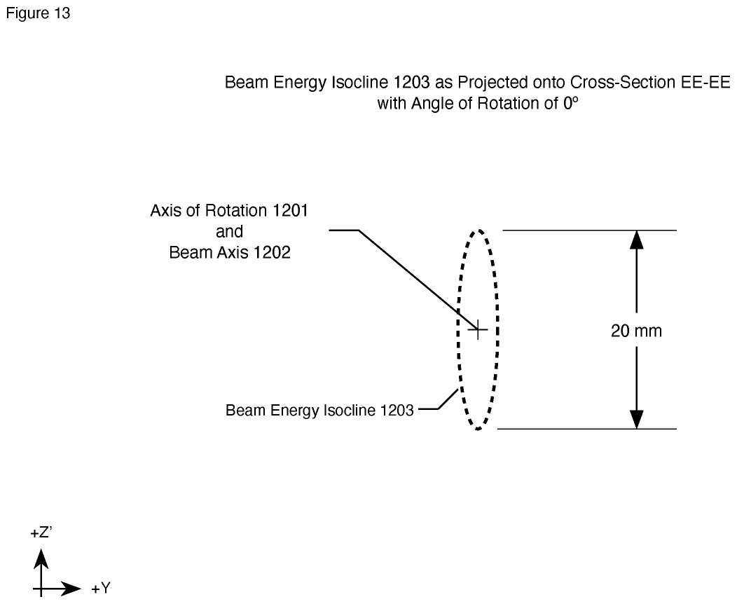

Beam energy isocline 1203 is the planar isocline that encloses 4 sigma (i.e., =99.38%) of the energy of laser beam 471. In accordance with the illustrative embodiment, beam energy isocline 1203—after shaping by cylindrical lens 1212-2—is an ellipse normal to the direction of propagation, as shown in FIG. 13. It will be clear to those skilled in the art, after reading this disclosure, how to make and use alternative embodiments of the present invention in which the beam energy isocline captures a different percentage of energy (e.g., 50%, 1/e², etc.). Furthermore, it will be clear to those skilled in the art, after reading this disclosure, how to make and use alternative embodiments of the present invention in which the beam energy isocline has a different shape normal to the direction of propagation (e.g., circular, triangular, square, rectangular, irregular, etc.).

Instrument housing 1204 is an aluminum cylinder that establishes and maintains the relative spatial position of optical cable 451, collimating lens 1211-1, collimating lens 1211-2, rotary bearing 1221-1, rotary bearing 1221-2, and position-controlled actuator 1222. It will be clear to those skilled in the art, after reading this disclosure, how to make and use instrument housing 1204.

Control cable 1205 is an electrical cable that carries signals from controller 409 to position-controlled actuator 1222, which enable controller 409 to continually direct what angle laser beam 471 is to be rotated to. It will be clear to those skilled in the art how to make and use control cable 1205.

Collimating lens 1211-1 and collimating lens 1211-2 compose a two-stage collimator that collimates laser beam 471 as it is emitted from the end of optical cable 451. In accordance with the illustrative embodiment, laser beam 471 exits optical cable 451 with a diameter of 300 μm and a numerical aperture of 0.2 and exits collimating lens 1211-2 with beam energy isocline 1303 that is circular and 6 mm in diameter. Collimating lens 1211-1 and collimating lens 1211-2 are identical, and each is a short-focal length spherical plano-convex lens, as is commercially available from, for example and without limitation, IPG Photonics, Thorlabs, and Edmund Optics. Collimating lens 1211-1 and collimating lens 1211-2 are steadfastly affixed, 25 mm apart, to instrument housing 1204 so that they do not move or rotate independently of instrument housing 1204.

Although the illustrative embodiment comprises a two-stage collimator, it will be clear to those skilled in the art, after reading this disclosure, how to make and use alternative embodiments of the present invention that comprise a collimator with a different number of stages (e.g., one stage, three stages, four stages, five stages, etc.). Furthermore, it will be clear to those skilled in the art, after reading this disclosure, how to make and use alternative embodiments of the present invention that comprise a collimator that produces a beam with different characteristics. It will be clear to those skilled in the art how to make and use collimating lens 1211-1 and collimating lens 1211-2.

Cylindrical lens 1212-1 and cylindrical lens 1212-2 compose a two-stage optical beam shaper that changes beam energy isocline 1203 from circular to elliptical. Although the illustrative embodiment uses two lenses to perform this task, it will be clear to those skilled in the art, after reading this disclosure, how to make and use alternative embodiments that compose a different number of lenses (e.g., one lens, three lenses, four lenses, etc.). Furthermore, it will be clear to those skilled in the art, after reading this disclosure, how to make and use alternative embodiments of the present invention that omit a shaper altogether, and, instead project a laser beam with a circular beam energy isocline onto the filament. In those cases, the axis of rotation is offset a distance s from the beam axis, where s is greater than zero.

Cylindrical lens 1212-1 is a cylindrical plano-concave lens with a nominal focal length of −100 mm. The purpose of cylindrical lens 1212-1 is to change beam energy isocline 1203 from circular to elliptical. Cylindrical lens 1212-1 is made of ultraviolet fused silica and is available, for example and without limitation, from Thorlabs Inc. as part number LK4245RM-B.

Cylindrical lens 1212-1 is steadfastly affixed to the inside of bearing shroud 1223 so that:
(i) the axis of the lens' cylinder is parallel to the Y axis when beam energy isocline 1203 at cross-section EE-EE is rotated to angle 0°, and
(ii) cylindrical lens 1212-1 is 25 mm from collimating lens 1211-2, and
(iii) cylindrical lens 1212-1 rotates as bearing shroud 1223 rotates.

It will be clear to those skilled in the art, after reading this disclosure, how to make and use cylindrical lens 1212-1.

Cylindrical lens 1212-2 is a cylindrical plano-convex lens with a nominal focal length of 150 mm. The purpose of cylindrical lens 1212-2 is to narrow the minor axis of beam energy isocline 1203. Cylindrical lens 1212-2 is made of ultraviolet fused silica and is available, for example and without limitation, from Thorlabs Inc. as part number LI4643RM-B.

Cylindrical lens 1212-2 is steadfastly affixed to the inside of bearing shroud 1223 so that:
(i) the axis of the lens' cylinder is parallel to the Y axis when beam energy isocline 1203 at cross-section EE-EE is rotated to angle 90°, and
(ii) cylindrical lens 1212-2 is 25 mm from cylindrical lens 1212-1, and
(iii) cylindrical lens 1212-2 rotates as bearing shroud 1223 rotates.

It will be clear to those skilled in the art, after reading this disclosure, how to make and use cylindrical lens 1212-2.

Rotary bearing 1221-1 and rotary bearing 1221-2 are identical bearings that hold bearing shroud 1223 in instrument housing 1204 and enable bearing shroud 1223 to rotate freely under the control of position-controlled actuator 1822. The axis of rotary bearing 1221-1 and rotary bearing 1221-2 is axis of rotation 1201. It will be clear to those skilled in the art how to make and use rotary bearing 1221-1 and rotary bearing 1221-2.

Position-controlled actuator 1222 is an electromechanical motor that is capable of rotating bearing shroud 1223 around axis of rotation 1201 to any specific angle, as directed by controller 409. It will be clear to those skilled in the art how to make and use position-controlled actuator 1222.

Bearing shroud 1223 is a cylindrical aluminum tube that is steadfastly affixed to cylindrical lens 1212-1, cylindrical lends 1212-2, rotary bearing 1221-1, and rotary bearing 1221-2. It will be clear to those skilled in the art how to make and use bearing shroud 1223.

FIG. 13 depicts beam energy isocline 1203 at cross-section EE-EE (which is normal to axis of rotation 1201), approximately 200 mm from cylindrical lens 1212-2, and with laser beam 471 at an angle of rotation of θ=0°. In FIG. 13, it can be seen that beam energy isocline 1203 is anisotropic with respect to both axis of rotation 1201 and beam axis 1202. It will be clear to those skilled in the art, however, after reading this disclosure, how to make and use alternative embodiments of the present invention in which the beam energy isocline is isotropic with respect to the beam axis but anisotropic with respect to the axis of rotation.

It is well known to those skilled in the art that the general equation of an ellipse centered at the origin with major and minor axes lying along the coordinate axes is:

$$\frac{{x}^{2}}{{a}^{2}} + \frac{{y}^{2}}{{b}^{2}} = 1 \qquad ( Eq . 1 )$$

Furthermore, the general equation of an ellipse centered at the origin and rotated by an angle of rotation θ is:

$$\frac{{( x cos θ + y sin θ )}^{2}}{{a}^{2}} + \frac{{( x sin θ - y cos θ )}^{2}}{{b}^{2}} = 1 \qquad ( Eq . 2 )$$

If the point where axis of rotation 1201 and beam axis 1202 intersect cross-section EE-EE is considered the origin and the plane containing cross-section EE-EE is considered the Y-Z plane, then the Equation 2 is the general equation for beam energy isocline 1203 as projected onto cross-section EE-EE.

The specific equation for beam energy isocline 1203 with angle of rotation θ and as projected onto cross-section EE-EE is (in millimeters):

$$\frac{{( x cos θ + y sin θ )}^{2}}{4} + \frac{{( x sin θ - y cos θ )}^{2}}{100} = 1 \qquad ( Eq . 3 )$$

The specific equation for beam energy isocline 1203, as depicted in FIG. 13 with an angle of rotation of θ=0°, is (in millimeters):

$$\frac{{x}^{2}}{4} + \frac{{y}^{2}}{100} = 1 \qquad ( Eq . 4 )$$

In accordance with the illustrative embodiment, laser beam 471 strikes feedstock 411 an angle of incidence of φ=30°. It will be clear to those skilled in the art, after reading this disclosure, how to make and use alternative embodiments of the present invention in which the laser beam strikes the feedstock at any angle of incidence.

FIG. 14 depicts laser beam 471—with an angle of rotation of θ=0° and an angle of incidence of φ=30°—as it is projected onto the “feedstock plane.” For the purposes of this specification, the “feedstock plane” is defined as the plane that contains feedstock 411 in feedstock region 571-2 that is perpendicular to a second plane that contains both beam axis 1202 and feedstock 411 in feedstock region 571-2.

FIGS. 14, 15, and 16 are figurative and not drawn to scale; they do not depict hidden features, and FIGS. 14, 15, and 16 are described with respect to a right-handed coordinate system X′″—Y—Z′″ that is specific the feedstock plane. It will be clear to those skilled in the art, after reading this disclosure, how to rotate the coordinate system of the feedstock plane around the Y axis so as to place it in the X-Y-Z coordinate system of additive manufacturing system 400, as shown in FIGS. 4, 5a, and 5b.

Because laser beam 471 strikes feedstock 471 at an acute angle of incidence φ, beam energy isocline 1203, as projected onto the feedstock plane is elongated by

$$\frac{1}{sin φ}$$

in the Z′″ dimension. There is no elongation in the Y dimension.

If the point where axis of rotation 1201 and beam axis 1202 intersect the feedstock plane is considered the origin and the feedstock plane is considered the Y-Z plane, then the general equation for beam energy isocline 1202, rotated by an angle of rotation of θ and projected onto a plane at an angle of incidence of φ is:

$$\frac{{( x cos θ + y sin θ sin φ )}^{2}}{{a}^{2}} + \frac{{( x sin θ - y cos θ sin φ )}^{2}}{{b}^{2}} = 1 \qquad ( Eq . 5 )$$

The specific equation for beam energy isocline 1203, as depicted in FIG. 14 with an angle of rotation of θ=0°, is (in millimeters):

$$\frac{{x}^{2}}{4} + \frac{{y}^{2}}{400} = 1 \qquad ( Eq . 6 )$$

The length L of feedstock region 571-2 can be determined from Equation 5, and it equals

L=2y (Eq. 7)

where y is the positive root solution to Equation 5 for x=0. Setting x=0, θ=0° and φ=30° in Equation 5 yields y=20. From Equation 7, L=40. Therefore, the length L of feedstock region 571-2 in FIG. 14 is 40 mm.

FIG. 15 depicts laser beam 471—with an angle of rotation of θ=−15° and an angle of incidence of φ=30°—as is projected onto the feedstock plane. The specific equation for beam energy isocline 1203, as depicted in FIG. 15 with an angle of rotation of θ=−15° and an angle of incidence of φ=30°, can be found from Equation 5. The length of feedstock region 571-2 in FIG. 15 can be determined from Equation 7 where y is the positive root solution to Equation 5 for x=0, θ=−15° and φ=30°. In this case, Equation 5 yields y≈12.4, and Equation 7 yields L≈25. Therefore, the length L of feedstock region 571-2 in FIG. 15 is ≈25 mm.

FIG. 16 depicts laser beam 471—with an angle of rotation of θ=−90° and an angle of incidence of φ=30°—as is projected onto the feedstock plane. The specific equation for beam energy isocline 1203, as depicted in FIG. 16 with an angle of rotation of θ=−90° and an angle of incidence of φ=30°, can be found from Equation 5. The length of feedstock region 571-2 in FIG. 16 can be determined from Equation 7 where y is the positive root solution to Equation 5 for x=0, θ=−90° and φ=30°. In this case, Equation 5 yields y=4, and Equation 7 yields L=8. Therefore, the length L of feedstock region 571-2 in FIG. 16 is 8 mm.

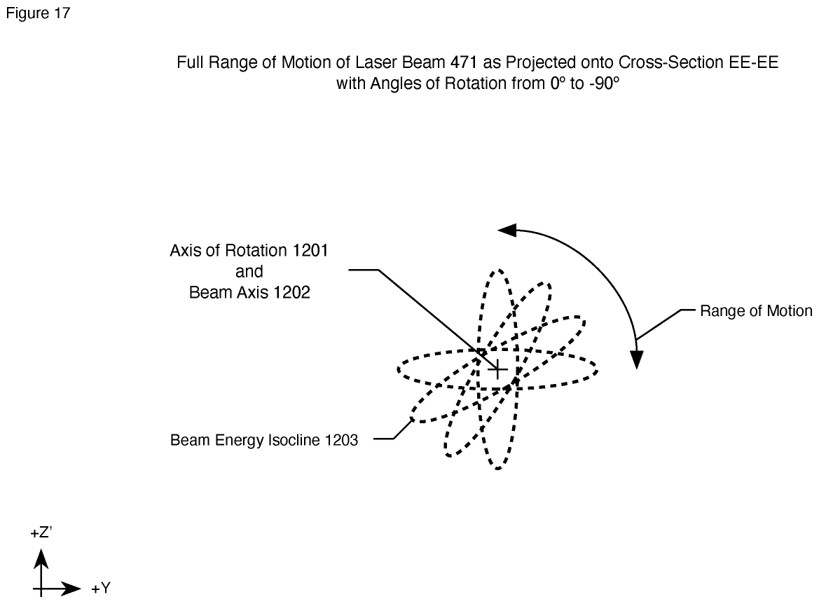

FIG. 17 depicts the full range of motion of beam energy isocline 1203 at cross-section EE-EE, with angles of rotation θ from 0° to −90°. It will be clear to those skilled in the art, after reading this disclosure, how to make and use alternative embodiments of the present invention that comprise any range of motion, and whether continuous or discrete.

FIG. 18a depicts a front orthographic representation of optical instrument 462 in accordance with the illustrative embodiment of the present invention. FIG. 18b depicts a side orthographic representation of optical instrument 462. FIG. 18c depicts a front orthographic representation of optical instrument 462 along cross-section FF-FF. FIG. 18d depicts a top orthographic representation of optical instrument along cross-section GG-GG.

FIGS. 18a, 18b, 18c, and 18d are figurative and not drawn to scale; they do not depict hidden features, and FIGS. 18a, 18b, 18c, 18d, 19 and 23 are described with respect to a right-handed coordinate system X″-Y -Z″ that is specific to optical instrument 462. It will be clear to those skilled in the art, after reading this disclosure, how to rotate the coordinate system of optical instrument 462 around the Y axis to place it in the X-Y-Z coordinate system of additive manufacturing system 400, as shown in FIGS. 4, 5a, and 5b.

Optical instrument 462 comprises: axis of rotation 1801, beam axis 1802, beam energy isocline 1803, instrument housing 1804, control cable 1805, collimating lens 1811-1, collimating lens 1811-2, cylindrical lens 1812-1, cylindrical lens 1812-2, rotary bearing 1821-1, rotary bearing 1821-2, position-controlled actuator 1822, and bearing shroud 1823.

Axis of rotation 1801 is a line in space around which collimating lens 1811-1, collimating lens 1811-2, cylindrical lens 1812-1, cylindrical lens 1812-2, bearing shroud 1823, and laser beam 472 rotate, under the direction of controller 409. In accordance with the illustrative embodiment, axis of rotation 1801 intersects workpiece region 572-2, as shown in FIGS. 20, 21, and 22. It will be clear to those skilled in the art, after reading this disclosure, how to make and use alternative embodiments of the present invention that in which the axis of rotation does not intersect the workpiece region (i.e., the axis of rotation is outside of the beam energy isocline).

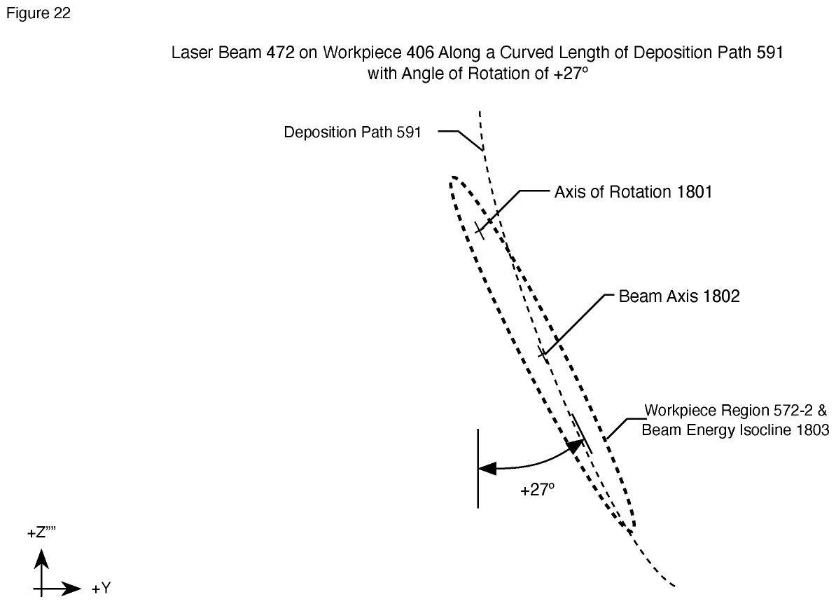

In accordance with the illustrative embodiment, axis of rotation 1801 intersects deposition path 591 when deposition path 591 is straight (as shown in FIG. 20), but might or might not intersect deposition path 591 depending on how deposition path 591 twists and turns (as shown, for example and without limitation, in FIGS. 21 and 22).

Beam axis 1802 is a line in space that is the energy-weighted centroid of the area enclosed by beam energy isocline 1803. In accordance with the illustrative embodiment, beam axis 1802 intersects axis of rotation 1801 at an angle of approximately 1.5°. It will be clear to those skilled in the art, after reading this disclosure, how to make alternative embodiments of the present invention in which the beam axis:
(i) is collinear with the axis of rotation, or
(ii) is parallel with the axis of rotation, or
(iii) is skew with the axis of rotation.

Beam energy isocline 1803 is the planar isocline that encloses 4 sigma (i.e., 99.38%) of the energy of laser beam 472. In accordance with the illustrative embodiment, beam energy isocline 1803—after shaping by cylindrical lens 1812-2 and projected onto cross-section HH-HH—is an ellipse normal to the direction of propagation, as shown in FIG. 19. It will be clear to those skilled in the art, after reading this disclosure, how to make and use alternative embodiments of the present invention in which the beam energy isocline captures a different percentage of energy (e.g., 50%, 1/e², etc.). Furthermore, it will be clear to those skilled in the art, after reading this disclosure, how to make and use alternative embodiments of the present invention in which the beam energy isocline is other than elliptical (e.g., circular, triangular, square, rectangular, irregular, etc.).

Instrument housing 1804 is an aluminum cylinder that establishes and maintains the relative spatial position of optical cable 452, rotary bearing 1821-1, rotary bearing 1821-2, and position-controlled actuator 1822. It will be clear to those skilled in the art, after reading this disclosure, how to make and use instrument housing 1804.

Control cable 1805 is an electrical cable that carries signals from controller 409 to position-controlled actuator 1822, which enable controller 409 to continually direct the angle of rotation θ of laser beam 472. It will be clear to those skilled in the art how to make and use control cable 1805.

Collimating lens 1811-1 and collimating lens 1811-2 compose a two-stage collimator that collimates laser beam 472 as it is emitted from the end of optical cable 452. In accordance with the illustrative embodiment, laser beam 472 exits optical cable 452 with a diameter of 300 μm and a numerical aperture of 0.2 and exits collimating lens 1811-2 with beam energy isocline 1303 that is circular and 6 mm in diameter. Collimating lens 1811-1 and collimating lens 1811-2 are identical, and each is a short-focal length spherical plano-convex lens, as is commercially available from, for example and without limitation, IPG Photonics, Thorlabs, and Edmund Optics. Collimating lens 1811-1 and collimating lens 1811-2 are steadfastly affixed, 25 mm apart, to the inside of bearing shroud 1823 so that they do not move or rotate independently of bearing shroud 1823.

Although the illustrative embodiment comprises a two-stage collimator, it will be clear to those skilled in the art, after reading this disclosure, how to make and use alternative embodiments of the present invention that comprise a collimator with a different number of stages (e.g., one stage, three stages, four stages, five stages, etc.). Furthermore, it will be clear to those skilled in the art, after reading this disclosure, how to make and use alternative embodiments of the present invention that comprise a collimator that produces a beam with different characteristics. It will be clear to those skilled in the art how to make and use collimating lens 1811-1 and collimating lens 1811-2.

Cylindrical lens 1812-1 and cylindrical lens 1812-2 compose a two-stage optical beam shaper that changes beam energy isocline 1803 from circular to elliptical. Although the illustrative embodiment uses two lenses to perform this task, it will be clear to those skilled in the art, after reading this disclosure, how to make and use alternative embodiments that compose a different number of lenses (e.g., one lens, three lenses, four lenses, etc.).

Cylindrical lens 1812-1 is a cylindrical plano-concave lens with a nominal focal length of −100 mm. The purpose of cylindrical lens 1812-1 is to change beam energy isocline 1803 from circular to elliptical. Cylindrical lens 1812-1 is made of ultraviolet fused silica and is available, for example and without limitation, from Thorlabs Inc. as part number LK4245RM-B.

Cylindrical lens 1812-1 is steadfastly affixed to the inside of bearing shroud 1823 so that:
(i) the axis of the lens' cylinder is parallel to the Y axis when beam energy isocline 1803 at cross-section EE-EE is rotated to angle of rotation of θ=0°, and
(ii) cylindrical lens 1812-1 is 25 mm from collimating lens 1811-2, and
(iii) cylindrical lens 1812-1 rotates as bearing shroud 1823 rotates.

It will be clear to those skilled in the art, after reading this disclosure, how to make and use cylindrical lens 1812-1.

Cylindrical lens 1812-2 is a cylindrical plano-convex lens with a nominal focal length of 150 mm. The purpose of cylindrical lens 1812-2 is to narrow the minor axis of beam energy isocline 1803. Cylindrical lens 1812-2 is made of ultraviolet fused silica and is available, for example and without limitation, from Thorlabs Inc. as part number LI4643RM-B.

Cylindrical lens 1812-2 is steadfastly affixed to the inside of bearing shroud 1823 so that:
(i) the axis of the lens' cylinder is parallel to the Y axis when beam energy isocline 1803 at cross-section EE-EE is rotated to angle of rotation of θ=90°, and
(ii) cylindrical lens 1812-2 is 25 mm from cylindrical lens 1812-1, and
(iii) cylindrical lens 1812-2 rotates as bearing shroud 1823 rotates.

It will be clear to those skilled in the art, after reading this disclosure, how to make and use cylindrical lens 1812-2.

Rotary bearing 1821-1 and rotary bearing 1821-2 are identical bearings that hold bearing shroud 1823 in instrument housing 1804 and enable bearing shroud 1823 to rotate freely under the control of position-controlled actuator 1822. Rotary bearing 1821-1 and rotary bearing 1821-2 rotate around axis of rotation 1801. It will be clear to those skilled in the art how to make and use rotary bearing 1821-1 and rotary bearing 1821-2.

Position-controlled actuator 1822 is an electromechanical motor that is capable of rotating bearing shroud 1823 around axis of rotation 1801 to any angle of rotation θ, as directed by controller 409. It will be clear to those skilled in the art how to make and use position-controlled actuator 1822.

Bearing shroud 1823 is an aluminum frame that is steadfastly affixed to collimating lens 1811-1, collimating lens 1811-2, cylindrical lens 1812-1, cylindrical lends 1812-2, rotary bearing 1821-1, and rotary bearing 1821-2. It will be clear to those skilled in the art how to make and use bearing shroud 1823.

FIG. 19 depicts beam energy isocline 1803 at cross-section HH-HH (which is normal to beam axis 1802), approximately 200 mm from cylindrical lens 1812-2, and with laser beam 472 at an angle of rotation of θ=0°. It should be noted that beam energy isocline 1803 is anisotropic with respect to both axis of rotation 1801 and beam axis 1802.

FIG. 20 depicts laser beam 472 as it irradiates workpiece region 572-2 along a straight length of deposition path 591 with an angle of rotation of θ=0°.

FIGS. 14, 15, and 16 are figurative and not drawn to scale; they do not depict hidden features, and FIGS. 14, 15, and 16 are described with respect to a right-handed coordinate system X″″-Y-Z″″ that is specific to workpiece region 572-2. It will be clear to those skilled in the art, after reading this disclosure, how to rotate the coordinate system of workpiece region 572-2 around the Y axis to place it in the X-Y-Z coordinate system of additive manufacturing system 400, as shown in FIGS. 4, 5a, and 5b.

Note that FIG. 20 is depicted in the coordinate system of additive manufacturing system 400, and that laser beam 472 irradiates workpiece region 572-2 at an angle of incidence of φ that changes as the contour of workpiece 406 changes. In accordance with the illustrative embodiment, axis of rotation 1801 intersects workpiece 406 at a location where deposition path 591 would be if deposition path were straight, and laser beam 472 is rotated so that beam axis 1802 intersects deposition path 591.

FIG. 21 depicts laser beam 472 as it irradiates workpiece region 572-2 along a curved length of deposition path 591 with an angle of rotation of θ=−27°. Note that FIG. 21 is depicted in the coordinate system of additive manufacturing system 400, and that laser beam 472 irradiates workpiece region 572-2 at an angle of incidence of φ that changes as the contour of workpiece 406 changes. In accordance with the illustrative embodiment, axis of rotation 1801 intersects workpiece 406 at a location where deposition path 591 would be if deposition path were straight, and laser beam 472 is rotated so that beam axis 1802 intersects deposition path 591.

FIG. 22 depicts laser beam 472 as it irradiates workpiece region 572-2 along a curved length of deposition path 591 with an angle of rotation of θ=+27°. Note that FIG. 21 is depicted in the coordinate system of additive manufacturing system 400, and that laser beam 472 irradiates workpiece region 572-2 at an angle of incidence of φ that changes as the contour of workpiece 406 changes. In accordance with the illustrative embodiment, axis of rotation 1801 intersects workpiece 406 at a location where deposition path 591 would be if deposition path were straight, and laser beam 472 is rotated so that beam axis 1802 intersects deposition path 591.

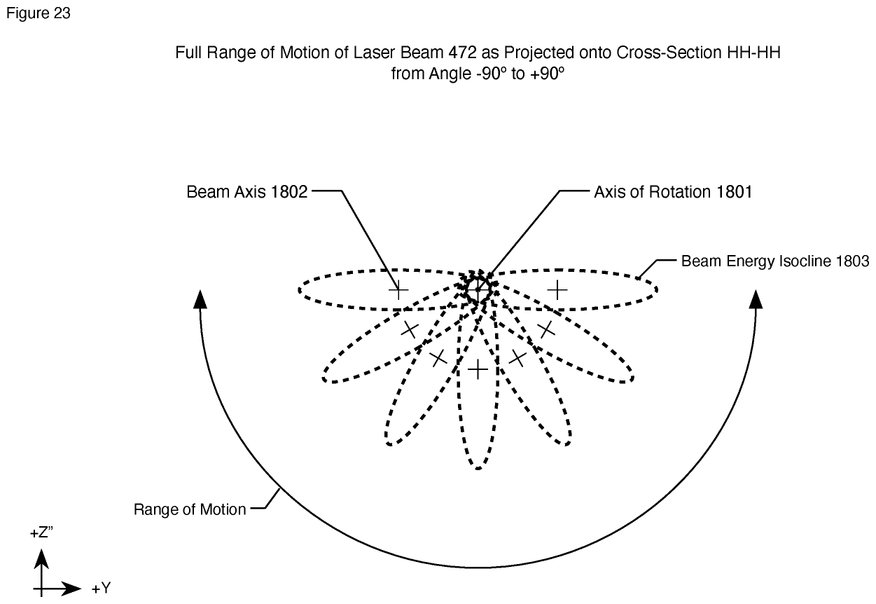

FIG. 23 depicts the range of motion of laser beam 472 around axis of rotation 1801, which is continuous from +90° to −90° (i.e., laser beam 472 can be rotated from any first angle in the range of motion to any second angle to any third angle in the range of motion, etc.). It will be clear to those skilled in the art, after reading this disclosure, how to make and use alternative embodiments of the present invention that comprise any range of motion, and whether continuous or discrete.

In accordance with the illustrative embodiment, axis of rotation 1801 is inside of beam energy isocline 1803, but it will be clear to those skilled in the art, after reading this disclosure, how to make and use alternative embodiments of the present invention in which the axis of rotation is outside of the beam energy isocline. Of course, whether the axis of rotation is inside or outside of the beam energy isocline is, at least partially, dependent on the threshold used to define the beam energy isocline.

The illustrative embodiment comprises one laser and one optical instrument for heating the feedstock, but it will be clear to those skilled in the art, after reading this disclosure, how to make and use alternative embodiments of the present invention that comprise a plurality of lasers and optical instruments for heating different segments of the feedstock.

The illustrative embodiment comprises one laser and one optical instrument for heating the workpiece, but it will be clear to those skilled in the art, after reading this disclosure, how to make and use alternative embodiments of the present invention that comprise a plurality of lasers and optical instruments for heating different workpiece regions of the workpiece.

What is claimed is:

1. A method comprising:
rotating a laser beam around an axis of rotation from a first angle to a second angle, wherein the first angle does not equal the second angle;
irradiating and heating a first segment of a filament with at least a first portion of the laser beam at the second angle during a first time-interval;
depositing and tamping the first segment of the filament onto a first portion of a workpiece during a second time-interval, wherein the second time-interval is after, and mutually exclusive of, the first time-interval;
rotating the laser beam around the axis of rotation from the second angle to a third angle, wherein the second angle does not equal the third angle;
irradiating and heating a second segment of the filament with at least a second portion of the laser beam at the third angle during a third time-interval, wherein the third time-interval is after, and mutually exclusive of, the first time-interval; and
depositing and tamping the second segment of the filament onto a second portion of the workpiece during a fourth time-interval, wherein the fourth time-interval is after, and mutually exclusive of, the third time-interval.

2. The method of claim 1 wherein the laser beam has an anisotropic beam energy isocline with respect to, and normal to, the axis of rotation.

3. The method of claim 1 wherein the laser beam has a beam energy isocline that is an ellipse normal to the filament.

4. The method of claim 1 further comprising:
measuring a temperature of the first segment of the filament during the first time-interval;
wherein the third angle is based on the temperature of the first segment of the filament during the first time-interval.

5. The method of claim 1 further comprising:
measuring a temperature of the second segment of the filament during the first time-interval;
wherein the third angle is based on the temperature of the second segment of the filament during the first time-interval.

6. The method of claim 1:
wherein the laser beam comprises a beam axis; and
wherein the beam axis and the axis of rotation are collinear.

7. The method of claim 1:
wherein the laser beam comprises a beam axis; and
wherein the beam axis and the axis of rotation intersect.

8. The method of claim 1:
wherein the laser beam comprises a beam axis; and
wherein the beam axis and the axis of rotation are parallel.

9. The method of claim 1 wherein the axis of rotation intersects the filament.

10. The method of claim 1 wherein rotating the laser beam around the axis of rotation from the first angle to the second angle comprises:
rotating a cylindrical lens.

11. The method of claim 1:
wherein the filament is deposited at a non-uniform rate;
wherein the second angle is based on a prediction of the interval between the first time-interval and the second time-interval; and
wherein the third angle is based on a prediction of the interval between the third time-interval and the fourth time-interval.

12. A method comprising:
rotating a laser beam around an axis of rotation from a first angle to a second angle, wherein the first angle does not equal the second angle;
irradiating and heating a first segment of a filament with at least a first portion of the laser beam at the second angle during a first time-interval;
depositing and tamping the first segment of the filament onto a first portion of a workpiece during a second time-interval, wherein the second time-interval is after, and mutually exclusive of, the first time-interval;
wherein the filament is deposited at a non-uniform rate; and
wherein the second angle is based on a prediction of the interval between the first time-interval and the second time-interval.

13. The method of claim 12 wherein the laser beam has an anisotropic beam energy isocline with respect to, and normal to, the axis of rotation.

14. The method of claim 12 wherein the laser beam has a beam energy isocline that is an ellipse normal to the filament.

15. The method of claim 12:
wherein the laser beam comprises a beam axis; and
wherein the beam axis and the axis of rotation are collinear.

16. The method of claim 12:
wherein the laser beam comprises a beam axis; and
wherein the beam axis and the axis of rotation intersect.

17. The method of claim 12:
wherein the laser beam comprises a beam axis; and
wherein the beam axis and the axis of rotation are parallel.

18. The method of claim 12 wherein the axis of rotation intersects the filament.

19. A method comprising:
collimating an uncollimated laser beam to generate a collimated laser beam;
shaping the collimated laser beam with a first cylindrical lens to generate a shaped laser beam;
rotating the first cylindrical lens around an axis of rotation from a first angle to a second angle, wherein the first angle does not equal the second angle;
irradiating and heating a first segment of a filament with at least a first portion of the shaped laser beam at the second angle during a first time-interval;
rotating the first cylindrical lens around the axis of rotation from the second angle to a third angle, wherein the second angle does not equal the third angle; and
irradiating and heating a second segment of the filament with at least a second portion of the shaped laser beam at the third angle during a second time-interval, wherein the second time-interval is after, and mutually exclusive of, the first time-interval.

20. The method of claim 19 wherein the laser beam has an anisotropic beam energy isocline with respect to, and normal to, the axis of rotation.

21. The method of claim 19 wherein the laser beam has a beam energy isocline that is an ellipse normal to the filament.

22. The method of claim 19 further comprising:
measuring a temperature of the first segment of the filament during the first time-interval;
wherein the third angle is based on the temperature of the first segment of the filament during the first time-interval.

23. The method of claim 19 further comprising:
measuring a temperature of the second segment of the filament during the first time-interval;
wherein the third angle is based on the temperature of the second segment of the filament during the first time-interval.

24. The method of claim 19 wherein the axis of rotation intersects the filament.
